(19) United States
(12) Patent Application Publication
(10) Pub. No.: US 2018/0297802 A1
(43) Pub. Date: Oct. 18, 2018

(54) DETECTOR, SHEET CONVEYING DEVICE INCORPORATING THE DETECTOR, SHEET FEEDING DEVICE INCORPORATING THE DETECTOR, IMAGE FORMING APPARATUS INCORPORATING THE DETECTOR, AND IMAGE READING DEVICE INCORPORATING THE DETECTOR

(71) Applicants: Masahiro Ishida, Kanagawa (JP); Toshiaki Takahashi, Tokyo (JP)

(72) Inventors: Masahiro Ishida, Kanagawa (JP); Toshiaki Takahashi, Tokyo (JP)

(73) Assignee: Ricoh Company, Ltd., Tokyo (JP)

(21) Appl. No.: 15/951,503

(22) Filed: Apr. 12, 2018

(30) Foreign Application Priority Data
Apr. 13, 2017 (JP) 2017-080117
Jul. 28, 2017 (JP) 2017-146101

(51) Int. Cl. B65H 5/38; B65H 3/06; B65H 3/68; B65H 29/52; B65H 7/20; G03G 15/16; H04N 1/12; B65H 43/06

(52) U.S. Cl. CPC B65H 5/38; B65H 3/0669; B65H 3/68; B65H 29/52; B65H 2404/5311; G03G 15/161; H04N 1/121; B65H 43/06; B65H 2404/5521; B65H 7/20

(57) ABSTRACT

A detector, which is included in a sheet feeding device, a sheet conveying device, an image forming apparatus and an image reading device, contacts and detects a sheet, and includes a base, a sheet contact face to which the sheet contacts, and a coat layer formed on the sheet contact face. A difference Δμ of a static coefficient of friction μs of the coat layer and a kinetic coefficient of friction μd of the coat layer is smaller than and equal to 0.12.

### CROSS-REFERENCE TO RELATED APPLICATIONS

This patent application is based on and claims priority pursuant to 35 U.S.C. § 119(a) to Japanese Patent Application Nos. 2017-080117, filed on Apr. 13, 2017, and 2017-146101, filed on Jul. 28, 2017, in the Japan Patent Office, the entire disclosures of each of which are hereby incorporated by reference herein.

### BACKGROUND

### Technical Field

This disclosure relates to a detector, a sheet conveying device incorporating the detector, a sheet feeding device incorporating the detector, an image forming apparatus incorporating the detector, and an image reading device incorporating the detector.

### Related Art

Various types of image forming apparatuses and image reading devices include a detector or detectors to detect a sheet by contacting the sheet to be conveyed, such as a paper and an original document.

A known detector that is disposed in a sheet conveyance passage through which a sheet having a toner image fixed in a fixing device, toward a sheet ejecting roller has been disclosed. The detector is a feeler to detect the sheet by contacting the sheet while the sheet is being conveyed in the sheet conveyance passage.

In addition, such image forming apparatuses and automatic document feeders of image reading devices include a sheet transfer guide made of resin material and disposed in a sheet conveyance passage of a sheet such as a recording medium and an original document, to guide the sheet that is being conveyed along the sheet conveyance passage.

A known sheet transfer guide is a member as described above, to guide a sheet being conveyed to a transfer section of an electrophotographic image forming apparatus. By forming the sheet transfer guide by a glass fiber reinforced acrylonitrile-butadiene-styrene resin, the sheet transfer guide can be enhanced in not only the rigidity and heat resistance of the sheet transfer guide but also the wear resistance when the sheet transfer guide is used for a long period of time.

By contrast, a sheet transfer guide made of resin material as described above generates sliding sound when the sheet slides along the sheet transfer guide, which turns to noise of the image forming apparatus.

It is to be noted that the above-described inconvenience is not limited to a sheet transfer guide but any member that slide along a target member.

### SUMMARY

At least one aspect of this disclosure provides a detector contacting and detecting a sheet and including a base, a sheet contact face to which the sheet contacts, and a coat layer formed on the sheet contact face.

Further, at least one aspect of this disclosure provides a sheet conveying device including a conveyance passage forming body, a sheet conveying body, the above-described detector and a rotary detector. The conveyance passage forming body is configured to define a sheet conveyance passage. The sheet conveying body is configured to convey a sheet through the sheet conveyance passage. The detector is configured to contact the sheet while the sheet is being conveyed through the sheet conveyance passage. The rotary detector is configured to detect rotation of the detector.

Further, at least one aspect of this disclosure provides a sheet feeding device including a sheet container, the above-described detector, and a rotary detector. The sheet container is configured to contain a sheet. The detector is configured to contact and detect the sheet contained in the sheet container. The rotary detector is configured to detect rotation of the detector.

Further, at least one aspect of this disclosure provides an image forming apparatus including a conveyance passage forming body, a sheet conveying body, the above-described detector, a rotary detector and an image forming device. The conveyance passage forming body is configured to define a sheet conveyance passage. The sheet conveying body is configured to convey a sheet through the sheet conveyance passage. The detector is configured to contact the sheet while the sheet is passing through the sheet conveyance passage. The rotary detector is configured to detect rotation of the detector. The image forming device is configured to form an image on the sheet.

Further, at least one aspect of this disclosure provides an image forming apparatus including a sheet container, the above-described detector, a rotary detector, and an image forming device. The sheet container is configured to contain a sheet. The detector is configured to contact and detect the sheet contained in the sheet container. The rotary detector is configured to detect rotation of the detector. The image forming device is configured to form an image on the sheet.

Further, at least one aspect of this disclosure provides an image reading device including a conveyance passage forming body, a sheet conveying body, the above-described detector, a rotary detector, and an image reader. The conveyance passage forming body is configured to define a sheet conveyance passage. The sheet conveying body is configured to convey a sheet through the sheet conveyance passage. The detector is configured to contact the sheet while the sheet is passing through the sheet conveyance passage. The rotary detector is configured to detect rotation of the detector. The image reader is configured to read an image formed on the sheet.

Further, at least one aspect of this disclosure provides an image reading device including a sheet container, the above-described detector, a rotary detector, and an image reader. The sheet container is configured to contain a sheet. The detector is configured to contact and detect the sheet contained in the sheet container. The rotary detector is configured to detect rotation of the detector. The image reader is configured to read an image formed on the sheet.

### BRIEF DESCRIPTION OF THE SEVERAL VIEWS OF THE DRAWINGS

An exemplary embodiment of this disclosure will be described in detail based on the following figured, wherein:

FIG. 1 is a diagram illustrating a schematic configuration of an image forming apparatus including a detector according to an embodiment of this disclosure;

FIG. 2 is a perspective view illustrating a partial cross section of a third sheet conveyance passage and parts disposed near the third sheet conveyance passage in an apparatus body of the image forming apparatus according to an embodiment of this disclosure;

FIGS. 3A, 3B and 3C are front views illustrating an exit sheet sensor and parts near the exit sheet sensor in the third sheet conveyance passage near a sheet ejecting roller of the image forming apparatus according to an embodiment of this disclosure;

FIGS. 4A and 4B are side views illustrating the exit sheet sensor, viewed from arrow B and arrow C in FIG. 3A, respectively, when the sheet is in contact or not in contact with the exit sheet sensor;

FIG. 5A is a position of the detector when the sheet is in contact with the exit sheet sensor;

FIG. 5B is a position of the detector when the sheet is not in contact with the exit sheet sensor;

FIG. 6A is a perspective view illustrating an inner conveyance guide of a fifth sheet conveyance passage (a sheet reversing passage) and the detector of a reversed sheet sensor before the sheet contacts, of the image forming apparatus according to an embodiment of this disclosure;

FIG. 6B is a perspective view illustrating the detector of the reversed sheet sensor, viewed from a rear side of the inner conveyance guide;

FIG. 6C is a front view illustrating the detector of the reversed sheet sensor;

FIG. 7A is a perspective view illustrating the inner conveyance guide of the fifth sheet conveyance passage (the sheet reversing passage) and the detector of the reversed sheet sensor when the sheet is being conveyed, of the image forming apparatus according to an embodiment of this disclosure;

FIG. 7B is a perspective view illustrating the detector of the reversed sheet sensor, viewed from the rear side of the inner conveyance guide;

FIG. 7C is a front view illustrating the detector of the reversed sheet sensor;

FIG. 8A is a front view illustrating a container sheet sensor when no sheet is contained in a sheet container of a sheet feeder of the image forming apparatus according to an embodiment of this disclosure;

FIG. 8B is an enlarged view illustrating the container sheet sensor;

FIG. 8C is a side view illustrating the container sheet sensor;

FIG. 9A is a perspective view illustrating the container sheet sensor when no sheet is contained in the sheet container of the sheet feeder;

FIG. 9B is an enlarged view illustrating the container sheet sensor;

FIG. 10A is a front view illustrating the container sheet sensor when a sheet is contained in the sheet container of the sheet feeder of the image forming apparatus according to an embodiment of this disclosure;

FIG. 10B is an enlarged view illustrating the container sheet sensor;

FIG. 10C is a side view illustrating the container sheet sensor;

FIG. 11 is a cross sectional view illustrating a part of the detector according to an embodiment of this disclosure;

FIG. 12 is a diagram illustrating an application device used for manufacturing the detector according to an embodiment of this disclosure;

FIG. 13 is an enlarged view illustrating a fixing section in the image forming apparatus according to an embodiment of this disclosure;

FIG. 14A is a perspective view illustrating a sheet transfer guide defining a third sheet conveyance passage in an apparatus body of the image forming apparatus according to an embodiment of this disclosure;

FIG. 14B is a cross sectional view illustrating the sheet transfer guide of FIG. 14A;

FIG. 14C is a cross sectional view illustrating a rib portion of the sheet transfer guide of FIG. 14A;

FIG. 15A is a perspective view illustrating a sheet transfer guide defining a second sheet conveyance passage in the apparatus body of the image forming apparatus according to an embodiment of this disclosure;

FIG. 15B is a cross sectional view illustrating the sheet transfer guide of FIG. 15A;

FIG. 15C is a cross sectional view illustrating a rib portion of the sheet transfer guide of FIG. 15A;

FIG. 16A is a perspective view illustrating a sheet transfer guide defining the second and third sheet conveyance passages in the apparatus body of the image forming apparatus according to an embodiment of this disclosure;

FIG. 16B is a cross sectional view illustrating the sheet transfer guide of FIG. 16A;

FIG. 16C is a cross sectional view illustrating a rib portion of the sheet transfer guide of FIG. 16A;

FIG. 17A is a perspective view illustrating a sheet transfer guide provided in an original document conveyance passage in an image reading device attached to the image forming apparatus according to an embodiment of this disclosure;

FIG. 17B is a cross sectional view illustrating the sheet transfer guide of FIG. 17A;

FIG. 17C is a cross sectional view illustrating a rib portion of the sheet transfer guide of FIG. 17A;

FIG. 18 is a diagram illustrating an application device used for manufacturing the sheet transfer guide according to an embodiment of this disclosure;

FIG. 19 is a diagram illustrating another application device used for manufacturing the sheet transfer guide according to an embodiment of this disclosure;

FIG. 20 is a diagram illustrating yet another application device used for manufacturing the sheet transfer guide according to an embodiment of this disclosure;

FIG. 21A is a front view illustrating yet another application device used for manufacturing the sheet transfer guide according to an embodiment of this disclosure;

FIG. 21B is an enlarged view illustrating the application device of FIG. 21A;

FIG. 22 is a perspective view illustrating opening and closing of a cover and a bypass tray;

FIG. 23 is a diagram illustrating a drive device provided to the apparatus body to rotate a rotary body such as a photoconductor;

FIG. 24 is a front view illustrating a step gear;

FIG. 25 is a diagram illustrating rollers that apply a transfer force to the sheet in the image forming apparatus, and a sheet container; and

FIG. 26 is a schematic view illustrating the sheet container.

### DETAILED DESCRIPTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

The terminology used herein is for describing particular embodiments and examples and is not intended to be limiting of exemplary embodiments of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of an image forming apparatus according to exemplary embodiments of this disclosure. Elements having the same functions and shapes are denoted by the same reference numerals throughout the specification and redundant descriptions are omitted. Elements that do not demand descriptions may be omitted from the drawings as a matter of convenience. Reference numerals of elements extracted from the patent publications are in parentheses so as to be distinguished from those of exemplary embodiments of this disclosure.

This disclosure is applicable to any image forming apparatus, and is implemented in the most effective manner in an electrophotographic image forming apparatus.

In describing preferred embodiments illustrated in the drawings, specific terminology is employed for the sake of clarity. However, the disclosure of this disclosure is not intended to be limited to the specific terminology so selected and it is to be understood that each specific element includes any and all technical equivalents that have the same function, operate in a similar manner, and achieve a similar result.

Referring now to the drawings, wherein like reference numerals designate identical or corresponding parts throughout the several views, preferred embodiments of this disclosure are described.

Descriptions are given of an image forming apparatus 100 according to an embodiment of this disclosure, with reference to the following figures.

The image forming apparatus 100 may be a copier, a facsimile machine, a printer, a multifunction peripheral or a multifunction printer (MFP) having at least one of copying, printing, scanning, facsimile, and plotter functions, or the like. According to the present example, the image forming apparatus 100 is an electrophotographic printer that prints toner images on recording media by electrophotography.

It is to be noted in the following examples that: the term “image forming apparatus” indicates an apparatus in which an image is formed on a recording medium such as paper, OHP (overhead projector) transparencies, OHP film sheet, thread, fiber, fabric, leather, metal, plastic, glass, wood, and/or ceramic by attracting developer or ink thereto; the term “image formation” indicates an action for providing (i.e., printing) not only an image having meanings such as texts and figures on a recording medium but also an image having no meaning such as patterns on a recording medium; and the term “sheet” is not limited to indicate a paper material but also includes the above-described plastic material (e.g., a OHP sheet), a fabric sheet and so forth, and is used to which the developer or ink is attracted. In addition, the “sheet” is not limited to a flexible sheet but is applicable to a rigid plate-shaped sheet and a relatively thick sheet.

Further, size (dimension), material, shape, and relative positions used to describe each of the components and units are examples, and the scope of this disclosure is not limited thereto unless otherwise specified.

Further, it is to be noted in the following examples that: the term “sheet conveying direction” indicates a direction in which a recording medium travels from an upstream side of a sheet conveying path to a downstream side thereof; the term “width direction” indicates a direction basically perpendicular to the sheet conveying direction.

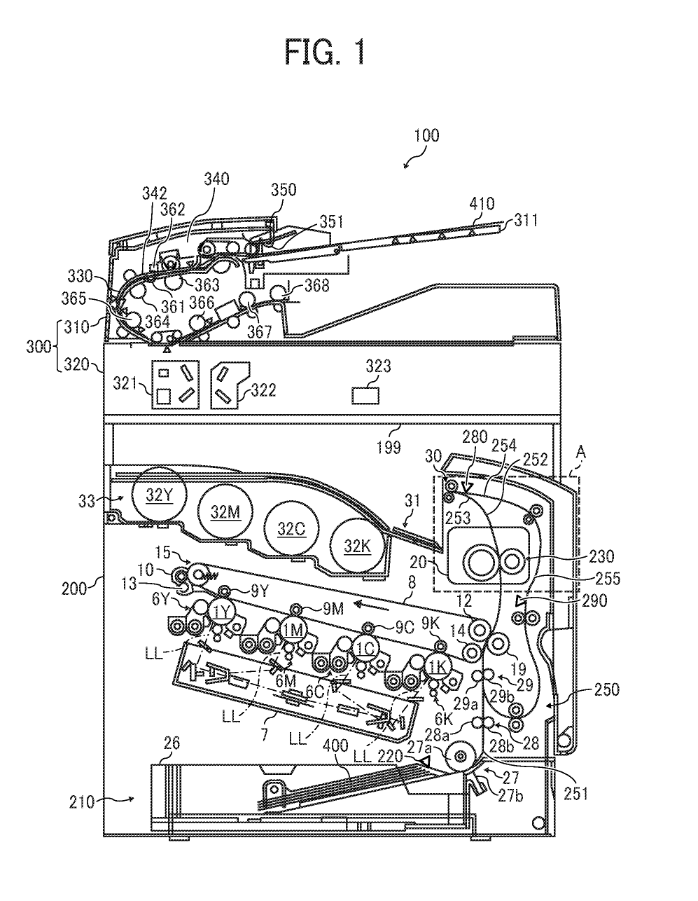

FIG. 1 is a diagram illustrating a schematic configuration of an image forming apparatus 100 including a detector according to an embodiment of this disclosure.

The image forming apparatus 100 is an electrophotographic image forming apparatus and includes an apparatus body 200 and an image reading device 300. The apparatus body 200 is a housing of a printer engine part. It is to be noted that the present embodiment describes an electrophotographic image forming apparatus. However, the image forming method of the image forming apparatus 100 may be other types such as an inkjet method.

The apparatus body 200 of the image forming apparatus 100 is a section in which a toner image is formed on a sheet 400 (such as a recording sheet) that functions as a recording medium that is fed and supplied from a sheet feeding device 210 that functions as a sheet supplying portion, based on image data of an image read by the image reading device 300 or image data that is sent by an external device.

The image reading device 300 includes an automatic document feeder (ADF) 310 and a scanner 320.

The ADF 310 feeds an original document 410 that is an image reading target sheet set by an operator, and the scanner 320 reads an image on the original document 410 fed by the ADF 310.

A sheet 400 and the original document 410 are target sheets to be transferred. The thickness of the target sheet such as the sheet 400 and the original document 410 is in a range, for example, from 50 μm to 500 μm. The sheet 400 and the original document 410 that include a high quality paper having the thickness of approximately 100 μm (for example, the thickness of 100 μm±10 μm) are also target sheets to be transferred.

The apparatus body 200 (that is a printer engine) includes four image forming units 6Y, 6M, 6C, and 6K to form yellow (Y), magenta (M), cyan (C), and black (K) toner images, respectively. The configurations of the image forming units 6Y, 6M, 6C, and 6K are basically identical to each other, except that the image forming units 6Y, 6M, 6C, and 6K include toners of different colors as image forming substances. Each of the image forming units 6Y, 6M, 6C, and 6K is replaced at the end of the service life. As illustrated in FIG. 1, the image forming units 6Y, 6M, 6C, and 6K includes drum-shaped photoconductors 1Y, 1M, 1C, and 1K, each of which functions as an image bearer, drum cleaning devices that function as a photoconductor drum cleaner, static eliminating devices, charging devices, and developing devices. Each of the image forming units 6Y, 6M, 6C, and 6K is detachably attachable to the apparatus body 200 of the image forming apparatus 100 and consumable parts provided in each of the image forming units 6Y, 6M, 6C, and 6K can be replaced at one time.

As illustrated in FIG. 1, an optical writing device 7 is disposed vertically below the image forming units 6Y, 6M, 6C, and 6K.

The optical writing device 7 functions as a latent image forming device. The optical writing device 7 emits a laser light LL based on image data to optically expose to the respective photoconductors 1Y, 1M, 1C, and 1K in the image forming units 6Y, 6M, 6C, and 6K. Due to this optical exposure, an electrostatic latent image is formed on the surface of each of the photoconductors 1Y, 1M, 1C, and 1K.

It is to be noted that, while causing a polygon motor to rotate a polygon mirror so as to deflect the laser light LL emitted by a light source in a main scanning direction (an axial direction of each of the photoconductors 1Y, 1M, 1C, and 1K), the optical writing device 7 irradiates the deflected laser light LL to each of the photoconductors 1Y, 1M, 1C, and 1K via multiple optical lenses and mirrors.

The image forming apparatus 100 further includes a sheet feeding device 210 that functions as a sheet feeder, below the optical writing device 7. The sheet feeding device 210 includes a sheet container 26 and a separation device 27 that is incorporated in the sheet container 26. The sheet container 26 contains multiple sheets 400 as a bundle of sheets. The separation device 27 includes a rotatable feed roller 27a and a separation pad 27b that contacts the feed roller 27a. A sheet separation nip region is formed between the feed roller 27a and the separation pad 27b.

The feed roller 27a of the separation device 27 contacts an uppermost sheet 400 placed on the bundle of sheets 400 contained in the sheet container 26. The feed roller 27a rotates to feed the sheet 400 to the sheet separation nip region. In a case in which multiple sheets 400 are conveyed to the sheet separation nip region in layer, the uppermost sheet 400 of the multiple sheets 400 contacts the feed roller 27a. The uppermost sheet 400 follows movement of the surface of the feed roller 27a, and moves in a sheet conveying direction in the sheet separation nip region. By contrast, the separation pad 27b that does not follow the movement of the surface of the feed roller 27a applies load resistance to the multiple sheets 400 other than the uppermost sheet 400. Due to the load resistance applied by the separation pad 27b, these multiple sheets 400 fail to follow the uppermost sheet 400 that continuously moves in the sheet conveying direction, and therefore remain in the sheet separation nip region. Accordingly, the separation device 27 separates the uppermost sheet 400 alone from the multiple sheets 400 fed from the sheet container 26 and conveys the uppermost sheet 400 from the sheet separation nip region toward a first sheet conveyance passage 251.

A pair of sheet conveying rollers 28 that functions as a contact conveyance body is disposed in a middle point in a longitudinal direction of the first sheet conveyance passage 251. The pair of sheet conveying rollers 28 includes a first sheet conveying roller 28a and a second sheet conveying roller 28b, both of which function as conveyance bodies. The first sheet conveying roller 28a and the second sheet conveying roller 28b form a sheet conveyance nip region therebetween. Of the two conveying rollers, at least the first sheet conveying roller 28a is driven to rotate by a drive device.

A pair of registration rollers 29 that functions as a contact conveyance body is disposed in a vicinity of a terminal end in the longitudinal direction of the first sheet conveyance passage 251. The pair of registration rollers 29 includes a first registration roller 29a and a second registration roller 29b, both of which function as contact conveyance bodies. The first registration roller 29a and the second registration roller 29b form a registration nip region that functions as a contact conveyance nip region therebetween. Of the two registration rollers, at least the first registration roller 29a is driven to rotate by a drive device.

The first sheet conveying roller 28a of the pair of sheet conveying rollers 28 starts rotating at a substantially same time or with a relatively short time lag as a timing when the feed roller 27a of the separation device 27 starts rotating. The leading end of the sheet 400 that is conveyed to the sheet conveyance passage from the sheet separation nip region of the separation device 27 is eventually held by the sheet conveyance nip region of the pair of sheet conveying rollers 28. The first sheet conveying roller 28a is rotated at a linear velocity faster than the feed roller 27a. At this time, the sheet 400 is pulled significantly taut between the sheet separation nip region and the sheet conveyance nip region. A large torque is applied to the feed roller 27a, and therefore a torque limiter operates so that the feed roller 27a is rotated with movement of the sheet 400. At this time the torque limiter operates irregularly, and therefore a back tension is applied to the sheet 400 irregularly. Further, the sheet 400 slips on the first sheet conveying roller 28a, which promotes wear of the first sheet conveying roller 28a.

After the sheet 400 is fed from the sheet conveyance nip region by rotation of the first sheet conveying roller 28a toward the pair of registration rollers 29, the leading end of the sheet 400 contacts the registration nip region. At this time, the rotation of the pair of registration rollers 29 is stopped, and therefore the sheet 400 fails to enter the registration nip region but gradually starts warping. According to this warping of the sheet 400, skew of the sheet 400 is corrected.

After the sheet 400 starts to be fed from the sheet conveyance nip region of the pair of sheet conveying rollers 28, upon a predetermined timing, rotation of the feed roller 27a of the separation device 27 and rotation of the pair of sheet conveying rollers 28 are caused to stop. Accordingly the conveyance of the sheet 400 is temporarily stopped while the leading end of the sheet 400 is being warped.

An intermediate transfer unit 15 is disposed above the image forming units 6Y, 6M, 6C, and 6K in FIG. 1. The intermediate transfer unit 15 includes an intermediate transfer belt 8 that functions as an intermediate transfer body. The intermediate transfer belt 8 rotates endlessly with being stretched. The intermediate transfer unit 15 includes the intermediate transfer belt 8, four primary transfer bias rollers 9Y, 9M, 9C, and 9K, a belt cleaning device 10, a secondary transfer backup roller 12, a cleaning backup roller 13, and a tension roller 14.

The intermediate transfer belt 8 includes three rollers disposed inside a loop. While being stretched by the three rollers, the intermediate transfer belt 8 is driven by at least one of the three rollers and is rotated endlessly in a counterclockwise direction in FIG. 1. The primary transfer bias rollers 9Y, 9M, 9C, and 9K contact the photoconductors 1Y, 1M, 1C, and 1K with the intermediate transfer belt 8 interposed therebetween and form respective primary transfer nip regions with the photoconductors 1Y, 1M, 1C, and 1K, respectively.

In this configuration of the present embodiment, each of the primary transfer bias rollers 9Y, 9M, 9C, and 9K applies a transfer bias having a polarity opposite the toner (for example, a positive polarity) to the back face of the intermediate transfer belt 8 (i.e., an inner circumferential surface of the loop of the intermediate transfer belt 8). The rollers in the configuration except the primary transfer bias rollers 9Y, 9M, 9C, and 9K are electrically grounded. In the course in which a yellow toner image formed on the photoconductor 1Y, a magenta toner image formed on the photoconductor 1M, a cyan toner image formed on the photoconductor 1C, and a black toner image formed on the photoconductor 1K pass the primary transfer nip regions along with endless movement of the intermediate transfer belt 8, the yellow, magenta, cyan, and black toner images are sequentially transferred onto a surface of the intermediate transfer belt 8 as primary transfer. Accordingly, a four color superimposed toner image (hereinafter, referred to as a “four color toner image”) is formed on the surface of the intermediate transfer belt 8.

The secondary transfer backup roller 12 that is disposed inside the loop of the intermediate transfer belt 8 contacts a secondary transfer roller 19 that is disposed outside the loop of the intermediate transfer belt 8, with the intermediate transfer belt 8 interposed therebetween and forms a secondary transfer nip region with the secondary transfer roller 19. The four color toner image formed on the surface of the intermediate transfer belt 8 is transferred onto the sheet 400 in the secondary transfer nip region as secondary transfer.

After passing through the secondary transfer nip region, transfer residual toner that has not been transferred onto the sheet 400 remains on the intermediate transfer belt 8. The transfer residual toner remaining on the surface of the intermediate transfer belt 8 is removed by the belt cleaning device 10.

After the temporary stop of the rotation of the feed roller 27a and the rotation of the pair of sheet conveying rollers 28, at a timing in synchronization of arrival of the four-color toner image formed on the intermediate transfer belt 8 in the secondary transfer nip region, the rotation of the feed roller 27a and the rotation of the pair of sheet conveying rollers 28 resume. In addition, the pair of registration rollers 29 starts rotating. According to these operations, the sheet 400 is fed in the registration nip region, and then is conveyed from the registration nip region toward the secondary transfer nip region. Then, in the secondary transfer nip region, the four color toner image formed on the surface of the intermediate transfer belt 8 is transferred onto the sheet 400.

After being conveyed from the secondary transfer nip region, the sheet 400 having the four color toner image thereon is conveyed to the fixing device 20 including a pair of fixing rollers 230. When passing the pair of fixing rollers 230, the four color toner image transferred onto the sheet 400 is fixed to the sheet 400 by application of heat and pressure. Thereafter, the sheet 400 passes between rollers of a pair of sheet output rollers 30, and is discharged outside the apparatus body 200 of the image forming apparatus 100. After having been ejected by the pair of sheet output rollers 30 to the outside of the apparatus body 200 of the image forming apparatus 100, the sheet 400 is sequentially stacked on a sheet stacking portion 31 formed on an upper face of the apparatus body 200.

It is to be noted that the image forming apparatus 100 includes a sheet conveying device 250 that is formed by passages, units and components in the apparatus body 200, such as the first sheet conveyance passage 251, a second sheet conveyance passage 252, the third sheet conveyance passage 253, the fourth sheet conveyance passage 254, the fifth sheet conveyance passage 255, the pair of sheet output rollers 30, the pair of sheet conveying rollers 28, the pair of registration rollers 29, and the secondary transfer roller 19.

A bottle container 33 is disposed between the intermediate transfer unit 15 and the sheet stacking portion 31 disposed above the intermediate transfer unit 15. The bottle container 33 includes toner bottles 32Y, 32M, 32C, and 32K, each of which functions as a supplying toner container, to store the yellow, magenta, cyan, and black toners therein. Each of the toner bottles 32Y, 32M, 32C, and 32K is set to place on the bottle container 33 from above. The yellow, magenta, cyan, and black toners stored in the toner bottles 32Y, 32M, 32C, and 32K are supplied appropriately to the developing devices of the image forming units 6Y, 6M, 6C, and 6K by respective toner supplying devices, each of which functions as a toner conveyance body. The toner bottles 32Y, 32M, 32C, and 32K are detachably attached to the apparatus body 200 and separately disposed from the image forming units 6Y, 6M, 6C, and 6K.

A switchback device is disposed in the vicinity of the fixing device 20. In a duplex printing mode by which images are formed on both sides of the sheet 400, after the sheet 400 having an image on the first (front) side alone has passed through the fixing device 20, the switchback device causes the sheet 400 to reverse upside down. The vertically reversed sheet 400 passes through a fourth sheet conveyance passage 254 and a fifth sheet conveyance passage 255 and toward the registration nip region of the pair of registration rollers 29. After the sheet 400 is conveyed from the registration nip region to the secondary transfer nip region and the toner image is formed on the second (back) side of the sheet 400, the fixing device 20 fixes the toner image formed on the second side to the sheet 400. Then, the sheet 400 having images on both sides is conveyed to the pair of sheet output rollers 30 and is stacked on the sheet stacking portion 31.

The image reading device 300 is disposed above the apparatus body 200 (the printer engine) of the image forming apparatus 100. The image reading device 300 includes the ADF 310 and the scanner 320. The image reading device 300 is fixed on a rack 199 having two legs and fixed to the back face of the apparatus body 200. There is a relatively large space between the sheet stacking portion 31 of the apparatus body 200 and the rack 199. The sheet 400 is stacked in the space on the sheet stacking portion 31.

The scanner 320 of the image reading device 300 includes a fixed reading unit 321 and a movable reading unit 322.

The movable reading unit 322 is disposed immediately below a second exposure glass. The movable reading unit 322 can move optical components such as a light source and multiple reflection mirrors in left and right directions (in a horizontal direction) in FIG. 1. The second exposure glass is fixedly mounted on an upper wall of a casing of the scanner 320 so as to contact the original document 410. In the course of moving the optical components from left to right in FIG. 1, the light source emits the light. After a surface of the original document 410 placed on the second exposure glass reflects the light, the reflected laser light LL is further reflected on multiple reflection mirrors until an image reading sensor 323 that is secured to the scanner 320 receives the reflected light.

By contrast, the fixed reading unit 321 includes a light source, multiple reflection mirrors, and multiple image reading sensors such as charge coupled device (CCD) sensors. The fixed reading unit 321 is disposed immediately below a first exposure glass that is fixedly mounted on the upper wall of the casing of the scanner 320 so as to contact the original document 410. When the original document 410 that is conveyed by the ADF 310 passes over the first exposure glass, the light source emits light. After a first face (a lower face) of the original document 410 sequentially reflects the light, the reflected light is further reflected on multiple reflection mirrors until the image reading sensor 323 receives the reflected light. With the above-described operations, the first face of the original document 410 is scanned without moving the optical components such as the light source and the multiple reflection mirrors.

It is to be noted that the ADF 310 includes a second face reading sensor that optically scans a second face of the original document 410.

In a case in which a bundle of original documents formed by multiple original documents 410 accumulated in layers is set on the ADF 310, the original documents 410 can be conveyed one by one automatically. The ADF 310 includes multiple pairs of document conveying rollers 363, 364, 365, 366, 367 and 368, each of which function as a sheet conveying body. Consequently, the image formed on the original document 410 that is automatically conveyed by the multiple pairs of document conveying rollers 363, 364, 365, 366, 367 and 368 to the image reading device 300 one by one can be read by the fixed reading unit 321 in the scanner 320 and a second fixed reading unit in the ADF 310. In this case, a copy start button is pressed after the bundle of original documents is set on an original document loading table 311 of the ADF 310. Then, the ADF 310 starts conveyance of the original documents 410 to convey each original document 410 sequentially from top of the bundle of original documents loaded on the original document loading table 311. In the course of conveying the original documents 410, immediately after the original document 410 is reversed, the original document 410 is caused to pass right above the fixed reading unit 321 of the scanner 320. At this time, the image on the first face of the original document 410 is read by the fixed reading unit 321 of the scanner 320.

In the image forming apparatus 100 having the above-described configuration, the apparatus body 200 includes the first sheet conveyance passage 251, the second sheet conveyance passage 252, the third sheet conveyance passage 253, the fourth sheet conveyance passage 254 and the fifth sheet conveyance passage 255. Each of the first sheet conveyance passage 251, the second sheet conveyance passage 252, the third sheet conveyance passage 253, the fourth sheet conveyance passage 254 and the fifth sheet conveyance passage 255 functions as a sheet conveyance passage through which the sheet 400 is conveyed.

In the first sheet conveyance passage 251, the sheet 400 fed from the sheet feeding device 210 one by one is conveyed therethrough. The sheet 400 contained in the sheet container 26 is fed by the feed roller 27a and is conveyed to a secondary transfer position where the secondary transfer backup roller 12 and the secondary transfer roller 19 are disposed facing each other, via the pair of sheet conveying rollers 28 and the pair of registration rollers 29. At the secondary transfer position, the toner image formed on the intermediate transfer belt 8 is transferred onto the sheet 400. A container sheet sensor 220 that functions as a sheet detecting device detects presence of the sheet 400, that is, whether there is the sheet 400 on the sheet container 26 in which the sheet 400 to be conveyed in the first sheet conveyance passage 251 is contained.

In the second sheet conveyance passage 252, the sheet 400 onto which the toner image is formed at an image forming position passes through a fixing nip region of the pair of fixing rollers 230 of a fixing section A where the toner image is fixed to the sheet 400. The sheet 400 is then conveyed to be output onto the sheet stacking portion 31 via the pair of sheet output rollers 30.

In the third sheet conveyance passage 253, in a single-side printing operation, after having an image fixed thereto, the sheet 400 is conveyed to be discharged to the sheet stacking portion 31 via the pair of sheet output rollers 30. In the third sheet conveyance passage 253, in a duplex printing operation, after having an image fixed on a front side thereof at an image forming position, the sheet 400 is then conveyed to the pair of sheet output rollers 30. Then, the pair of sheet output rollers 30 changes the direction of rotation at a predetermined timing at which the trailing end of the sheet 400 approaches the pair of sheet output rollers 30. Accordingly, the sheet 400 is conveyed toward the fourth sheet conveyance passage 254. The trailing end of the sheet 400 in the third sheet conveyance passage 253 is detected by an exit sheet sensor (fixing device exit sheet sensor) 280 that functions as a sheet detecting device.

In the fourth sheet conveyance passage 254, in the duplex printing operation, the sheet 400 that has been conveyed through the third sheet conveyance passage 253 is further conveyed toward the fifth sheet conveyance passage (sheet reversing passage) 255 so that an image is formed on the back side or the sheet 400.

In the fifth sheet conveyance passage (sheet reversing passage) 255, the sheet 400 fed from the fourth sheet conveyance passage 254 is conveyed to a secondary transfer position where the secondary transfer backup roller 12 and the secondary transfer roller 19 are disposed facing each other via the pair of registration rollers 29. At the secondary transfer position, the toner image formed on the intermediate transfer belt 8 is transferred onto the back side of the sheet 400. The sheet 400 in the fifth sheet conveyance passage (sheet reversing passage) 255 is detected by a reversed sheet sensor 290 that functions as a sheet detecting device.

The image reading device 300 includes an original document conveyance passage 330 that functions as a sheet conveyance passage to pass the original document 410 therethrough. The original document conveyance passage 330 is defined by a sheet transfer guide 340 that includes a guide face 342 that has a curved portion to which the original document 410 contacts during conveyance. In the original document conveyance passage 330, the original document 410 that has been fed from the ADF 310 is conveyed to a document image reading position in the scanner 320. Whether there is the original document 410 on the original document loading table 311 of the ADF 310 is detected by an original document sensor 350 that functions as a sheet detecting device. It is to be noted that the detector 361 and the original document sensor 362 have the same function as the detector 351 and the original document sensor 350. It is also to be noted that whether there is the original document 410 along the sheet transfer guide 340 of the ADF 310 is detected by an original document sensor 362 and a detector 361 functioning as a sheet detecting device.

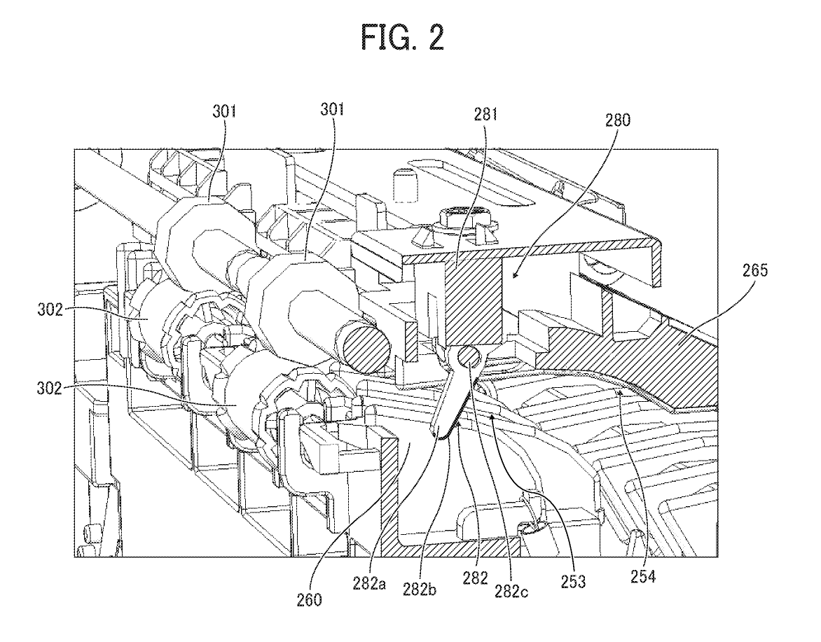

FIG. 2 is a perspective view illustrating a partial cross section of the third sheet conveyance passage 253 and parts disposed near the third sheet conveyance passage 253 in the apparatus body 200 of the image forming apparatus 100 according to an embodiment of this disclosure.

In FIG. 2, the third sheet conveyance passage 253 is defined by a sheet transfer guide 260 provided to the fixing section A side of the pair of sheet output rollers 30 that includes a sheet discharging roller 301 and a pressure roller 302 disposed facing each other. The sheet 400, which has been reversed and conveyed by the pair of sheet output rollers 30 that rotates in the reverse direction in the duplex printing operation, is conveyed along the lower face of the sheet transfer guide 265 that defines the third sheet conveyance passage 253.

The exit sheet sensor (the fixing device exit sheet sensor) 280 is disposed in the fixing section A side of the third sheet conveyance passage 253 near the pair of sheet output rollers 30. The exit sheet sensor 280 includes a sensor body 281 and a detector (feeler) 282. The detector 282 includes a rotary shaft 282c that is rotatably supported by the sensor body 281. As described below, a coat layer is provided on a sheet contact face of the detector 282 to which a sheet contacts, so as to reduce the wear of the detector 282 caused by contact of a sheet

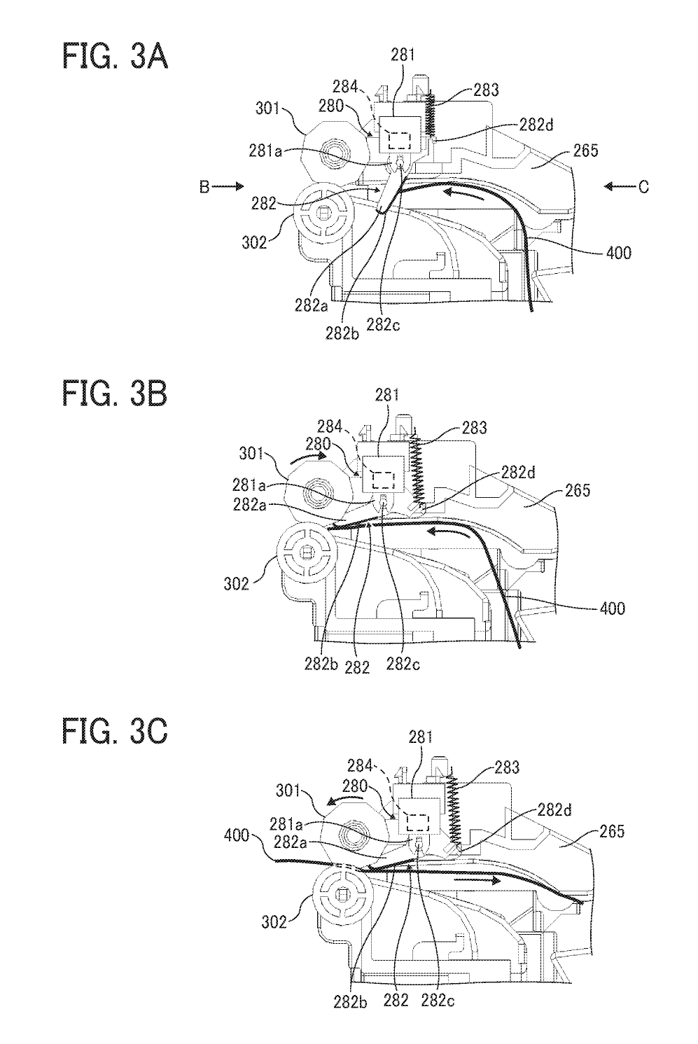

FIGS. 3A, 3B and 3C are front views illustrating the exit sheet sensor 280 and parts near the exit sheet sensor 280 in the third sheet conveyance passage 253 near the pair of sheet output rollers 30 of the image forming apparatus 100 according to an embodiment of this disclosure. FIG. 3A illustrates a state immediately before the leading end of the sheet 400 that is conveyed from the fixing section A contacts the detector 282 of the exit sheet sensor 280. FIG. 3B illustrates a state in which the sheet 400 that is conveyed from the fixing section A contacts the detector 282 of the exit sheet sensor 280 and is detected by the detector 282 and immediately before the sheet 400 is held by the pair of sheet output rollers 30. FIG. 3C illustrates a state in which the sheet 400 conveyed by the pair of sheet output rollers 30, which has been controlled to reverse the direction of rotation in the duplex printing operation, is conveyed toward the fourth sheet conveyance passage 254 while contacting the detector 282.

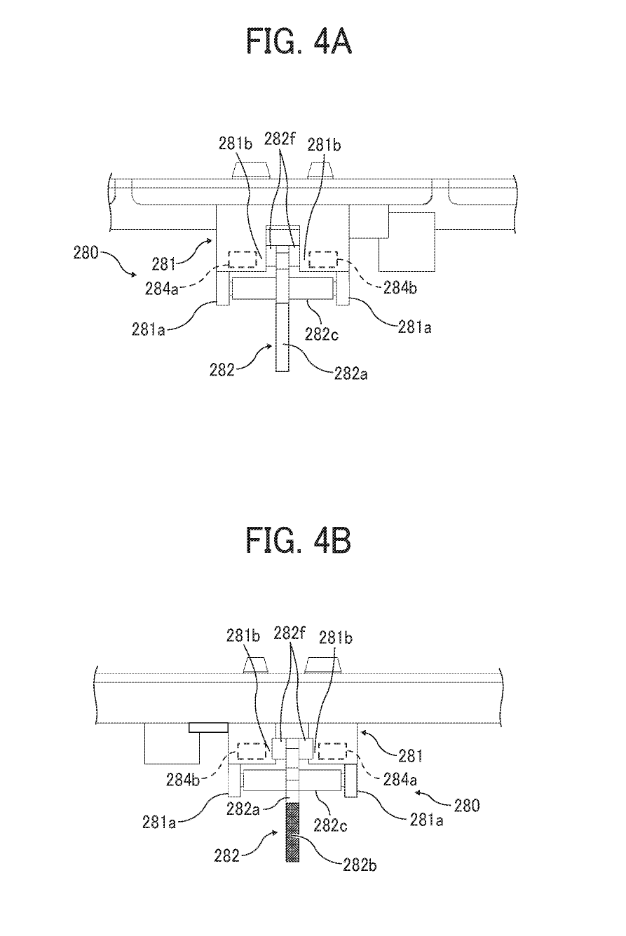

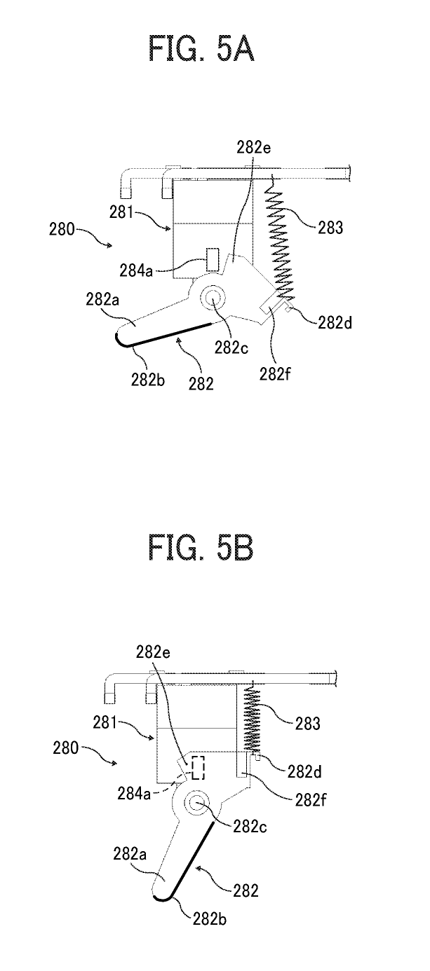

FIGS. 4A and 4B are side views illustrating the exit sheet sensor 280, viewed from arrow B and arrow C in FIG. 3A, respectively, when the sheet 400 is in contact or not in contact with the exit sheet sensor 280. Further, FIG. 5A is a position of the detector 282 when the sheet 400 is in contact with the exit sheet sensor 280 and FIG. 5B is a position of the detector 282 when the sheet 400 is not in contact with the exit sheet sensor 280.

In FIGS. 3A through 5B, the rotary shaft 282c of the detector 282 of the exit sheet sensor 280 is rotatably supported by a shaft support 281a of the sensor body 281. The detector 282 has a sheet detection arm 282a that extends toward one end of the detector 282 about the rotary shaft 282c of the detector 282. A surface of the sheet detection arm 282a contacts the sheet 400. A spring 283 that functions as a biasing member is provided at an opposed end 282d, relative to the sensor body 281. The spring 283 biases the detector 282 and an abutting portion 282f abuts against a rotary regulating member 281b disposed on the sensor body 281 side. According to this configuration, the sheet detection arm 282a is located at a predetermined position of the third sheet conveyance passage 253, as illustrated in FIGS. 3A, 4A, 4B and 5B

As the sheet detection arm 282a of the detector 282 contacts the sheet 400 that is being conveyed through the third sheet conveyance passage 253, the detector 282 rotates against the biasing force applied by the spring 283, as illustrated in FIGS. 3B, 3C and 5A.

Rotation of the detector 282 is detected by a light transmission type optical sensor 284 that functions as a rotary detector that is disposed at a position where a detection target 282e of the detector 282 passes. The optical sensor 284 may include a light emitting part 284a and a light receiving part 284b disposed facing each other, for example, with a passing position of the detection target 282e located therebetween.

Here, when the sheet 400 passes as illustrated in FIGS. 3B, 3C and 5A, light emitted by the light emitting part 284a reaches the light receiving part 284b to be received thereby, so as to detect that the sheet 400 is passing the passing position. By contrast, when the sheet 400 does not pass as illustrated in FIGS. 3A and 5B, light emitted by the light emitting part 284a is blocked by the detection target 282e of the detector 282 and does not reach the light receiving part 284b to be received. Accordingly, it is detected that the sheet 400 is not passing the passing position.

At the exit sheet sensor 280 having the above-described configuration, since the sheet 400 and the detector 282 contact and slide on each other when the sheet 400 is passing, it is likely that the sheet contact face of the detector 282 is worn. Specifically, since the exit sheet sensor 280 is disposed near the upper part of the fixing device 20 where the temperature rises, the temperature of the detector 282 increases due to heat of the fixing device 20, and therefore the sheet contact face of the detector 282 is easily worn.

The exit sheet sensor 280 is located in the third sheet conveyance passage 253 where the sheet 400 performs reciprocating motion during the duplex printing and is susceptible to heat generated by the fixing device 20. For these reasons, the degree of wear of the exit sheet sensor 280 increases due to contact and slide with the sheet 400. Therefore, there is a case that the leading end of the detector (feeler) 282 is cut sharply. As a result, it is likely that, when a thin paper is printed in a duplex printing mode, the thin paper is damaged or torn by the leading end of the detector 282 that has been sharply cut. Further, in a case in which such a damaged sheet is continuously conveyed, it is likely to cause a paper jam in the sheet conveyance passage.

Further, the biasing force applied by the spring 283 may be reduced in order to reduce the wear of the detector 282 and the sheet 400, the sliding with the sheet 400, and a rub mark generated on the image formed face of the sheet 400 after image formation. However, as the biasing force of the spring 283 decreases, it is likely that the accuracy in detection of the sheet 400 deteriorates due to lack of rotation of the detector 282 without rotating by the predetermined angle and that the detector 282 does not return to a predetermined rotation position in a no sheet passing state. In addition, it is likely to take a longer time for the detector 282 to return to the predetermined rotation position in the no sheet passing state, after the sheet 400 has passed by the detector 282.

In order to address these inconveniences, the configuration in the present embodiment includes a coat layer 282b on the sheet contact face of the detector 282. By so doing, even when the greater biasing force of the spring 283 is set, the wear on the sheet contact face of the detector 282 can be reduced.

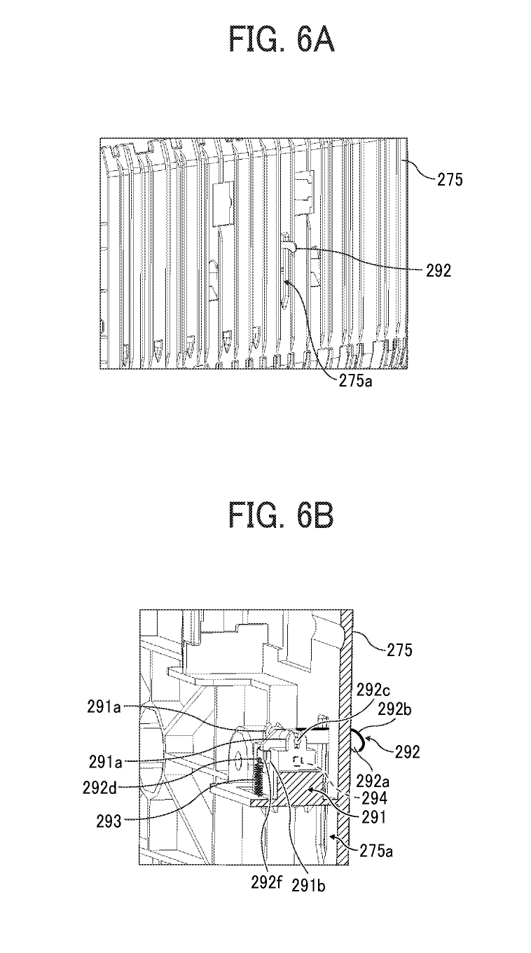

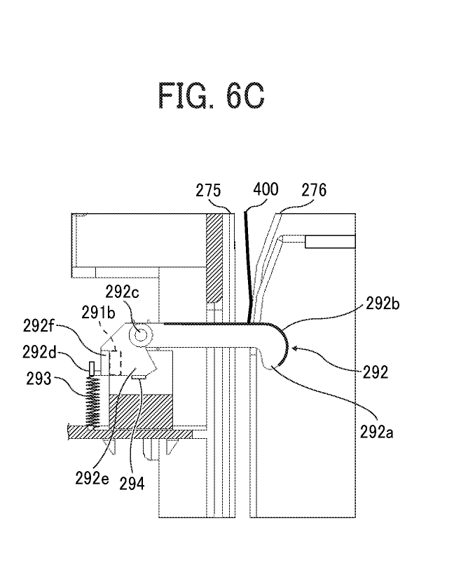

Now, FIGS. 6A, 6B, 6C, 7A, 7B and 7C are diagrams illustrating a configuration of the reversed sheet sensor 290 that functions as a sheet detecting device provided to the fifth sheet conveyance passage (sheet reversing passage) 255 of the image forming apparatus 100 according to an embodiment of this disclosure.

FIG. 6A is a perspective view illustrating an inner conveyance guide 275 of the fifth sheet conveyance passage (sheet reversing passage) 255 and a detector 292 of the reversed sheet sensor 290 before the sheet contacts, of the image forming apparatus 100 according to an embodiment of this disclosure. FIG. 6B is a perspective view illustrating the detector 292 of the reversed sheet sensor 290, viewed from the rear side of the inner conveyance guide 275. FIG. 6C is a front view illustrating the detector 292 of the reversed sheet sensor 290.

The detector 292 of the reversed sheet sensor 290 includes a rotary shaft 292c that is rotatably supported by a shaft support 291a of a sensor body 291. The detector 292 further includes a sheet detection arm 282a that extends toward one end of the detector 292 about the rotary shaft 292c of the detector 292. A surface of the sheet detection arm 292a contacts the sheet 400. A spring 293 that functions as a biasing member is provided at an opposed end 292d, relative to the sensor body 291. The spring 293 biases the detector 292. At the same time, an abutting portion 292f of the detector 292 abuts against a rotation regulating member 291b disposed near the sensor body 291. Consequently, the leading end of the sheet detection arm 292a projects from an opening (cut portion) 275a of the inner conveyance guide 275, and therefore is located at a predetermined position in the fifth sheet conveyance passage (sheet reversing passage) 255 between and defined by the inner conveyance guide 275 and an outer conveyance guide 276.

FIG. 7A is a perspective view illustrating the inner conveyance guide 275 of the fifth sheet conveyance passage (sheet reversing passage) 255 and the detector 292 of the reversed sheet sensor 290 while the sheet 400 is passing the fifth sheet conveyance passage (sheet reversing passage) 255, of the image forming apparatus 100 according to an embodiment of this disclosure. FIG. 7B is a perspective view illustrating the detector 292 of the reversed sheet sensor 290, viewed from the rear side of the inner conveyance guide 275. FIG. 7C is a front view illustrating the detector 292 of the reversed sheet sensor 290.

As the sheet detection arm 282a of the detector 282 contacts the sheet 400 that is being conveyed through the third sheet conveyance passage (sheet reversing passage) 253, the detector 292 rotates against the biasing force applied by the spring 293.

Rotation of the detector 292 is detected by a light transmission type optical sensor 294 that functions as a rotary detector that is disposed at a position where a detection target 292e of the detector 292 passes. The optical sensor 294 may include a light emitting part 294a and a light receiving part 294b disposed facing each other, for example, with a passing position of the detection target 292e located therebetween.

Here, when the sheet 400 passes, light emitted by the light emitting part 294a reaches the light receiving part 294b to be received thereby, so as to detect that the sheet 400 is passing the passing position. By contrast, when no sheet passes by the detector 292, light emitted by the light emitting part 294a is blocked by the detection target 292e of the detector 292 and does not reach the light receiving part 294b to be received. Accordingly, it is detected that the sheet 400 is not passing the passing position.

Even in the reversed sheet sensor 290 having the above-described configuration, since the sheet 400 and the detector 292 contact and slide on each other when the sheet 400 passes by the detector 292, it is likely that the sheet contact face of the detector 292 is worn. Further, since the reversed sheet sensor 290 is disposed near the upper part of the fixing device 20 where the temperature rises, the temperature of the detector 292 increases due to heat of the fixing device 20, and therefore the sheet contact face of the detector 292 is easily worn.

Further, the biasing force applied by the spring 293 may be reduced in order to reduce the wear of the detector 292 and the sheet 400, the sliding with the sheet 400, and a rub mark generated on the image formed face of the sheet 400 after image formation. However, as the biasing force of the spring 293 decreases, it is likely that the accuracy in detection of the sheet 400 deteriorates due to lack of rotation of the detector 292 without rotating by the predetermined angle and that the detector 292 does not return to a predetermined rotation position in the no sheet passing state. In addition, it is likely to take a longer time for the detector 292 to return to the predetermined rotation position in the no sheet passing state, after the sheet 400 has passed by the detector 292.

In order to address these inconveniences, the configuration in the present embodiment includes a coat layer 292b on the sheet contact face of the detector 292. By so doing, even when the greater biasing force of the spring 293 is set, the wear on the sheet contact face of the detector 292 can be reduced.

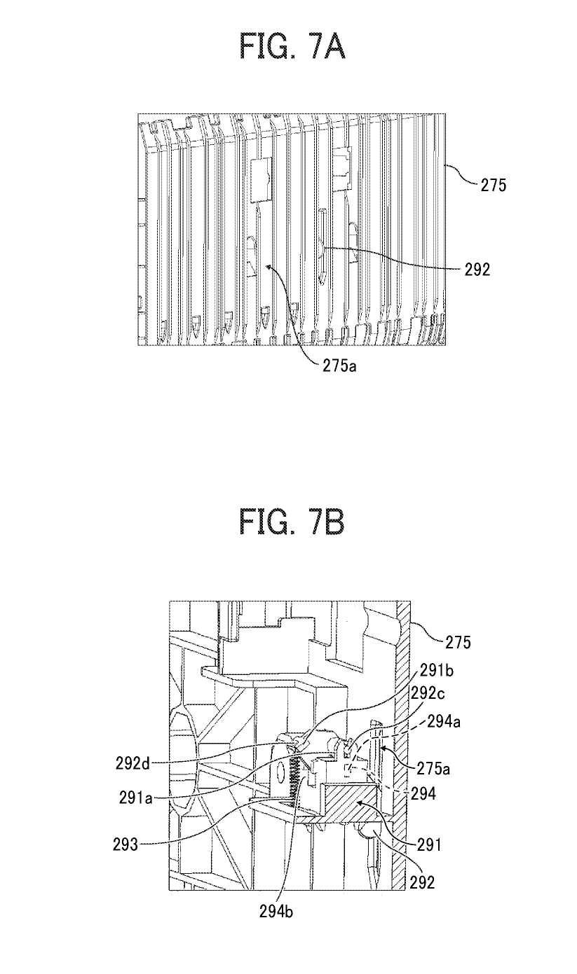

FIG. 8A is a front view illustrating a container sheet sensor 220 when no sheet is contained in the sheet container 26 of the sheet feeding device 210 of the image forming apparatus 100 according to an embodiment of this disclosure. FIG. 8B is an enlarged view illustrating the container sheet sensor 220. FIG. 8C is a side view illustrating the container sheet sensor 220.

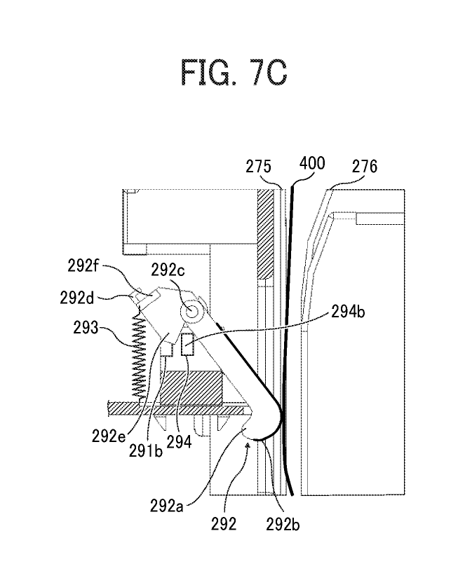

FIG. 9A is a perspective view illustrating the container sheet sensor 220 when no sheet is contained in the sheet container 26 of the sheet feeding device 210. FIG. 9B is an enlarged view illustrating the container sheet sensor 220 of the sheet feeding device 210.

As illustrated in FIGS. 9A and 9B, the sheet feeding device 210 includes the sheet container (sheet tray) 26. The sheet container (sheet tray) 26 is detachably attachable to an apparatus body of the sheet feeding device 210 and is attached in a direction indicated by arrow D as illustrated in FIGS. 9A and 9B. Since the container sheet sensor 220 is attached to apparatus body of the sheet feeding device 210, when the sheet container 26 with the sheet 400 contained therein is attached to the apparatus body of the sheet feeding device 210, a detector (sheet detection feeler) 222 of the container sheet sensor 220 rotates in a direction indicated by arrow E (i.e., a direction perpendicular to the sheet conveying direction of the sheet 400).

The detector 222 of the container sheet sensor 220 includes a rotary shaft 222c that is rotatably supported by a shaft support 221a of a sensor body 221. The detector 222 further includes a sheet detection arm 222a that extends toward one end of the detector 222 about the rotary shaft 222c of the detector 222. A surface of the sheet detection arm 222a contacts the sheet 400. A spring 223 that functions as a biasing member is provided at an opposed end 222d, relative to the sensor body 221. The spring 223 biases the detector 222. At the same time, an abutting portion 222f of the detector 222 abuts against a rotation regulating member 221b disposed near the sensor body 221. Consequently, the leading end of the sheet detection arm 222a projects from an opening (cut portion) 26a of the sheet container 26, and therefore is located at a predetermined position.

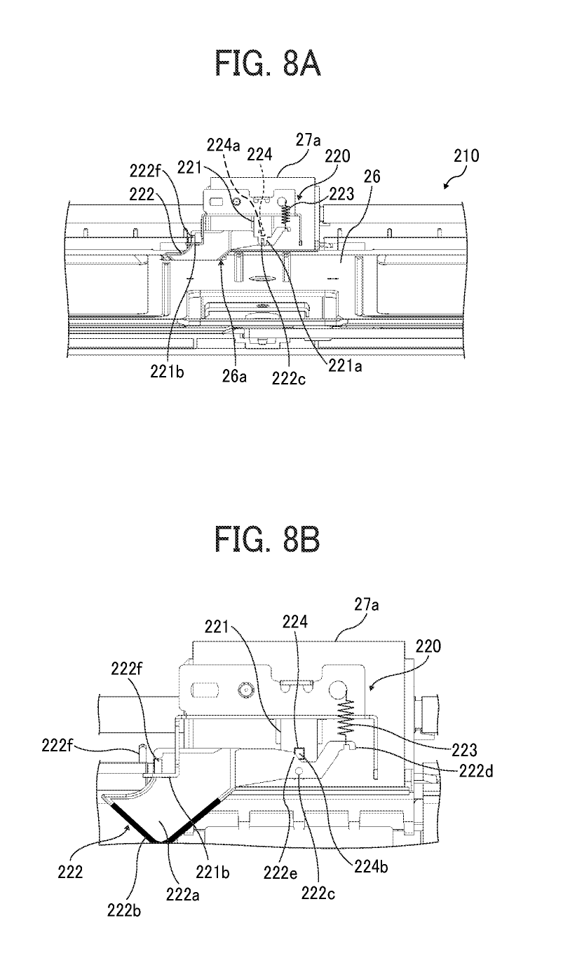

FIG. 10A is a front view illustrating the container sheet sensor 220 when a sheet is contained in the sheet container 26 of the sheet feeding device 210 of the image forming apparatus 100 according to an embodiment of this disclosure. FIG. 10B is an enlarged view illustrating the container sheet sensor 220. FIG. 10C is a side view illustrating the container sheet sensor 220.

As the sheet detection arm 222a of the detector 222 contacts the sheet 400 that is contained in the sheet container 26, the sheet detection arm 222a rotates against the biasing force applied by the spring 223.

Rotation of the detector 222 is detected by a light transmission type optical sensor 224 that functions as a rotary detector that is disposed at a position where a detection target 222e of the detector 222 passes. The optical sensor 224 may include a light emitting part 224a and a light receiving part 224b disposed facing each other, for example, with a passing position of the detection target 222e located therebetween.

Here, when the sheet 400 is contained in the sheet container 26, light emitted by the light emitting part 224a reaches the light receiving part 224b to be received thereby, so as to detect that the sheet 400 is loaded on the sheet container 26. By contrast, when the sheet 400 is not contained in the sheet container 26, light emitted by the light emitting part 224a is blocked by the detection target 222e of the detector 222 and does not reach the light receiving part 224b to be received. Accordingly, it is detected that the sheet 400 is not loaded on the sheet container 26.

Even in the container sheet sensor 220 having the above-described configuration, since the sheet 400 and the detector 222 contact and slide on each other when the sheet 400 contained in the sheet container 26 is fed from the sheet container 26, it is likely that the sheet contact face of the detector 222 is worn.

Further, the biasing force applied by the spring 223 may be reduced in order to reduce the wear of the detector 222 and the sheet 400, the sliding with the sheet 400, and a rub mark generated on the image formed face of the sheet 400 after image formation. However, as the biasing force of the spring 223 decreases, it is likely that the accuracy in detection of the sheet 400 deteriorates due to lack of rotation of the detector 222 without rotating by the predetermined angle and that the detector 222 does not return to a predetermined rotation position in the no sheet passing state. In addition, it is likely to take a longer time for the detector 222 to return to the predetermined rotation position in the no sheet passing state, after completion of passing of the sheet 400 by the detector 222.

In order to address these inconveniences, the configuration in the present embodiment includes a coat layer 222b on the sheet contact face of the detector 222. By so doing, even when the greater biasing force of the spring 223 is set, the wear on the sheet contact face of the detector 222 can be reduced.

It is to be noted that the original document sensor 350 that functions as a sheet detecting device to detect whether there is the original document 410 on the original document loading table 311 of the ADF 310 may have the same configuration as the container sheet sensor 220. Further, in the present embodiment, the following coat layer may be formed on a document contact face of a detector 351 of the original document sensor 350. In this case, even when the greater biasing force of a spring to a detector is set, the wear on the document contact face of the detector can be reduced.

It is also to be noted that the detector 361 and the original document sensor 362 have the identical function to the detector 351 and the original document sensor 350.

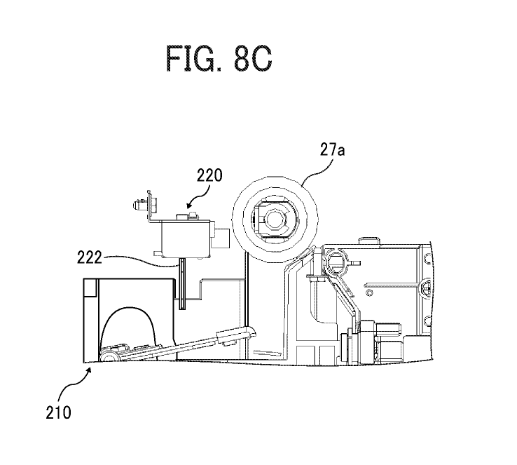

FIG. 11 is a cross sectional view illustrating part of the detectors 282, 292 and 222 provided to the image forming apparatus 100 according to the present embodiment of this disclosure. The detectors 282, 292 and 222 have respective sheet contact faces 282s, 292s and 222s to which the sheet 400 contacts. The coat layers 282b, 292b and 222b are formed on the sheet contact faces 282s, 292s and 222s, respectively. Further, the surface roughness Ra of each of the coat layers 282b, 292b and 222b may be smaller than base materials 282g, 292g and 222g, respectively.

Table 1 indicates examples of materials including resin material and filler, which can be used for the base materials (base metals) 282g, 292g and 222g of the detectors 282, 292 and 222 provided to the image forming apparatus 100 according to the present embodiment of this disclosure.

TABLE 1

| Resin Materials | Symbol |
|---|---|
| 1 | ABS-FR(17) |
| 2 | PET-GF |
| 3 | PBT + ABS |
| 4 | PC + ABS-(TD + MD)5FR(40) |

“ABS-FR(17)” indicated as Resin Material 1 in Table 1 represents a flame retardant acrylonitrile-butadiene-styrene (ABS) resin to which a flame retardant of combination of an aromatic bromine compound and an antimony compound is added.
“PET-GF” indicated as Resin Material 2 in Table 1 represents a polyethylene terephthalate resin including glass fiber as a filler.
“PBT + ABS” indicated as Resin Material 3 in Table 1 represents an alloy of polybutylene terephthalate and ABS resin.
“PC + ABS-(TD + MD)5FR(40)” indicated as Resin Material 4 in Table 1 represents an alloy of polycarbonate and acrylonitrile-butadiene-styrene including talcum powder (TD) and mineral powder (MD) as a filler.

Resin Materials 1 through 4 may include carbon fiber as a filler. Resin Materials 1, 3, and 4 in Table 1 may include glass fiber as a filler.

Further, the coat layers 282b, 292b and 222b of the detectors 282, 292 and 222 can be formed by applying liquid coat layer material to the sheet contact faces 282s, 292s and 222s by, for example, any of the application methods described below. Due to solidification of the coat layer materials applied onto the sheet contact faces 282s, 292s and 222s, the coat layers 282b, 292b and 222b have the surface roughness Ra smaller than the base materials (base metals) 282g, 292g and 222g. According to this configuration, the surface roughness of the sheet contact face of each detector can be reduced due to the coat layer, and the wear caused by contact of the sheet such as the sheet 400 on the sheet contact face can be reduced.

It is to be noted that the above-described coat layer materials may be a material that can be applied to the sheet contact faces 282s, 292s and 222s of the detectors 282, 292 and 222, respectively, and may be a material to have the above-described surface roughness in a solidified condition after application. Further, the above-described coat layer material may be a resin that contains solid lubricant.

Further, each of the coat layers 282b, 292b and 222b may be a layer that does not transfer to the sheet side even when the sheet such as the sheet 400 contacts thereto. In this case, the functions of the coat layers 282b, 292b and 222b can be maintained for a long period of time, and therefore the wear of the sheet contact faces 282s, 292s and 222s of the detectors 282, 292 and 222 can also be reduced for a long period of time.

Further, each of the coat layers 282b, 292b and 222b formed on the sheet contact faces 282s, 292s and 222s of the detectors 282, 292 and 222 may have a film thickness equal to or smaller than 50 μm. Further, each of the coat layers 282b, 292b and 222b may have a film thickness equal to 20 μm or greater.

Further, the surface roughness Ra of each of the coat layers 282b, 292b and 222b may be equal to or smaller than 0.2 μm. The surface roughness Ra of each of the base materials (base metals) 282g, 292g and 222g is equal to or greater than 0.2 μm and equal to or smaller than 3 μm.

Next, a description is given of a method of forming a coat layer having the surface roughness Ra smaller than the base material of the sheet transfer guide, to the sheet contact face of each of the detectors provided to the image forming apparatus 100.

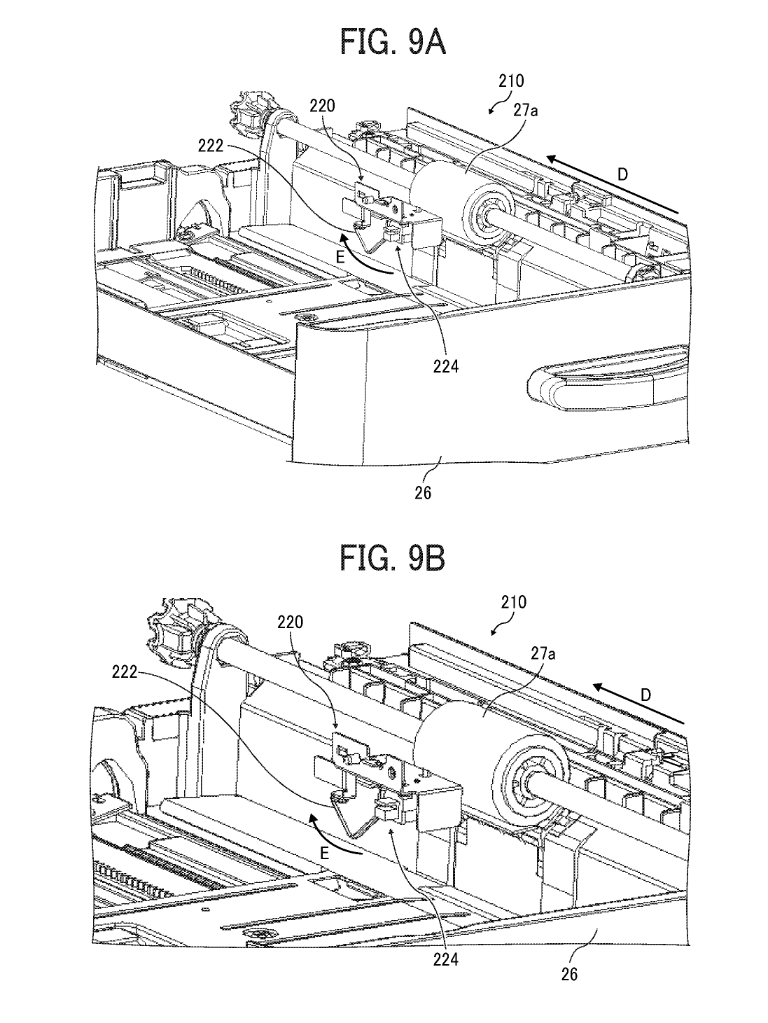

FIG. 12 is a diagram illustrating an application device 510 used for manufacturing the detector according to an embodiment of this disclosure.

In FIG. 12, the application device 510 applies liquid type coat layer material to the sheet contact face 282s of the detector 282 that defines the third sheet conveyance passage 253, as illustrated in FIG. 11. It is to be noted that a target to apply the coat layer material in the application device 510 is not limited to the detector 282 but may be the detectors 292 and 222.

The application device 510 illustrated in FIG. 12 includes an application roller type application device. The application device 510 includes an application roller 511 has a surface that is formed by material such as sponge, rubber, non-woven cloth, and felted fabric to which coating liquid that is liquid coat layer material is soaked. The application roller 511 rotates in a direction indicated by arrow J in FIG. 12 and slides in a direction indicated by arrow K and in a direction indicated by arrow L in FIG. 12. The direction K and the direction L are perpendicular to each other. The slide drive portion that causes the application roller 511 to slide is controlled by the controller that includes the CPU, based on a predetermined control program. It is to be noted that the application roller 511 may be rotated with movement of the sheet contact face 282s of the detector 282 or may be rotated by the rotary drive portion.

The rotary drive portion may include, for example, drive transmission components such as motors and gears, and drive shaft members. Further, the slide drive portion may include, for example, a slide guide portion, a movable portion that is guided by the slide guide portion, and a slide drive unit that drives the movable portion. The slide drive unit may include, for example, a belt drive method, a rack and pinion method, and a linear motor method.

In the application device 510 having the above-described configuration, the application roller 511 slides in the direction K and the direction L, respectively, so that the application roller 511 contacts the sheet contact face 282s of the detector 282. Accordingly, even when the sheet contact face 282s of the detector 282 is warped as illustrated in FIG. 12, the coating liquid can be uniformly applied to the sheet contact face 282s having the optional warped shape, so that the coat layer 282b having a uniform film thickness can be formed, as illustrated in FIG. 11.

It is to be noted that the application device 510 illustrated in FIG. 12 causes the application roller 511 to slide. However, the configuration of the application device 510 is not limited thereto. For example, the detector 282 can be slid instead of the application roller 511 or together with the application roller 511.

It is to be noted that the configurations of the above-described embodiments employ resin material as a base material of each of the detectors. However, the material used for a detector is not limited thereto. For example, the base material of a detector may be metal.

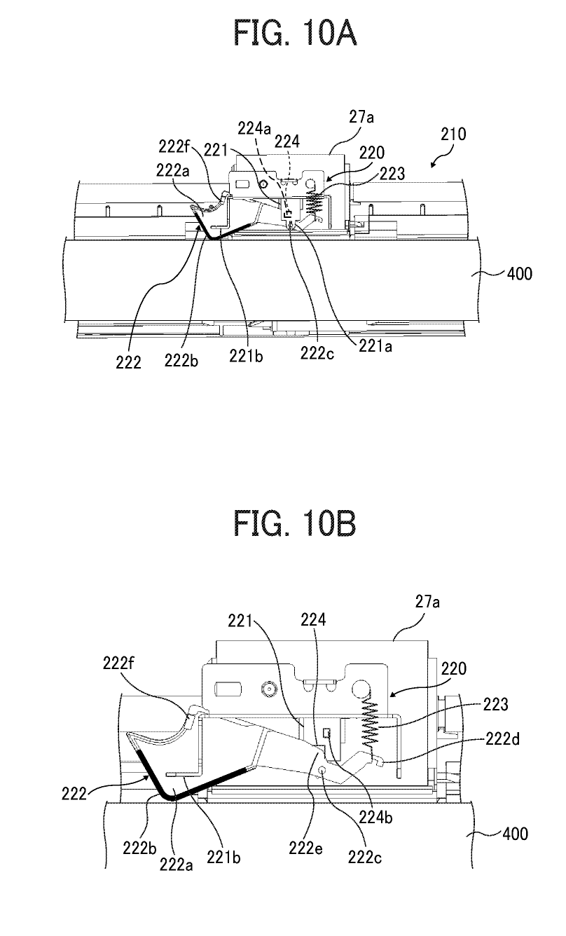

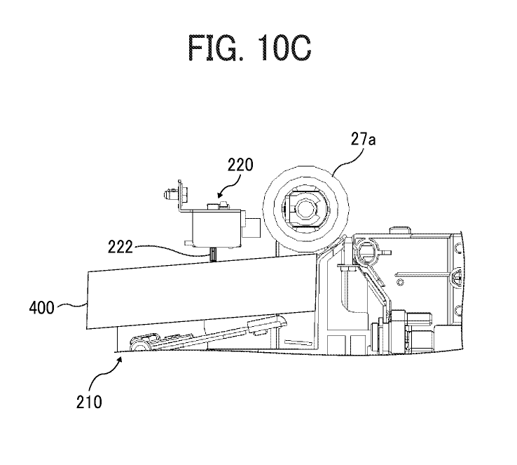

FIG. 13 is an enlarged view illustrating the fixing section A in the image forming apparatus 100 according to an embodiment of this disclosure. FIG. 14A is a perspective view illustrating a sheet transfer guide 260 that has the third sheet conveyance passage 253 provided to cause the sheet 400 to pass through after the fixing section, toward the sheet reverse passage 254. FIG. 14B is a cross sectional view illustrating the sheet transfer guide 260 of FIG. 14A. FIG. 14C is a cross sectional view illustrating a rib portion 261 of the sheet transfer guide 260 of FIG. 14A.

The sheet transfer guide 260 includes the rib portion 261 and a guide face 262. The rib portion 261 includes multiple projections extending in a sheet conveying direction B. The multiple projections of the rib portion 261 are partially formed at predetermined intervals in a width direction of the sheet 400 perpendicular to the sheet conveying direction B. The guide face 262 is a top surface of the rib portion 261 that contacts the sheet 400. In other words, the guide face 262 is a contact and slide portion with the sheet 400. Further, the guide face 262 including the top surface of the rib portion 261 has a concave shape or a recess curved in the sheet conveying direction B. Further, the guide face 262 of the sheet transfer guide 260 that contacts the sheet 400 has a coat layer 261b, as described below.

The coat layer 261b has a surface roughness Ra smaller than a surface roughness Ra of a base material 261a of the sheet transfer guide 260. Further, as described below, the difference Δμ of the static coefficient of friction μs and the kinetic coefficient of friction μd of the coat layer 261b is smaller than and equal to 0.12.

Here, the surface roughness Ra represents an arithmetic average roughness defined in JIS B0601 2001.

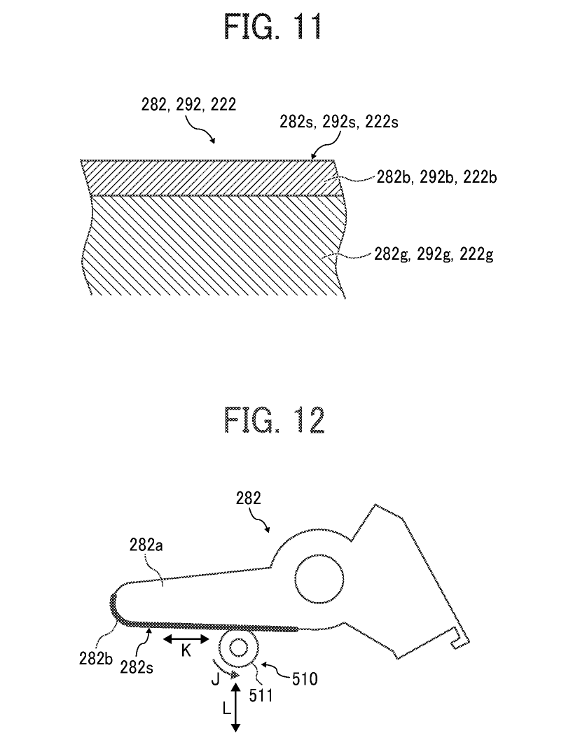

FIG. 15A is a perspective view illustrating a sheet transfer guide 265 that has the second sheet conveyance passage 252 provided to cause the sheet 400 to pass through after the fixing section A, toward the pair of sheet output rollers 30. FIG. 15B is a cross sectional view illustrating the sheet transfer guide 265 of FIG. 15A. FIG. 15C is a cross sectional view illustrating a rib portion 266 of the sheet transfer guide 265 of FIG. 15A.

The sheet transfer guide 265 includes the rib portion 266 and a guide face 267. The rib portion 266 includes multiple projections extending in a sheet conveying direction C. The multiple projections of the rib portion 261 are partially formed at predetermined intervals in the width direction of the sheet 400 perpendicular to the sheet conveying direction C. The guide face 267 is a top surface of the rib portion 266 that contacts the sheet 400. In other words, the guide face 267 is a contact and slide portion with the sheet 400. Further, the guide face 267 including the top surface of the rib portion 266 has a concave shape or a recess curved in the sheet conveying direction C.

Further, the guide face 267 of the sheet transfer guide 265 that contacts the sheet 400 has a coat layer 266b, as described below. The coat layer 266b has a surface roughness Ra smaller than a surface roughness Ra of a base material 266a of the sheet transfer guide 265. Further, as described below, the difference Δμ of the static coefficient of friction μs and the kinetic coefficient of friction μd of the coat layer 266b is smaller than and equal to 0.12.

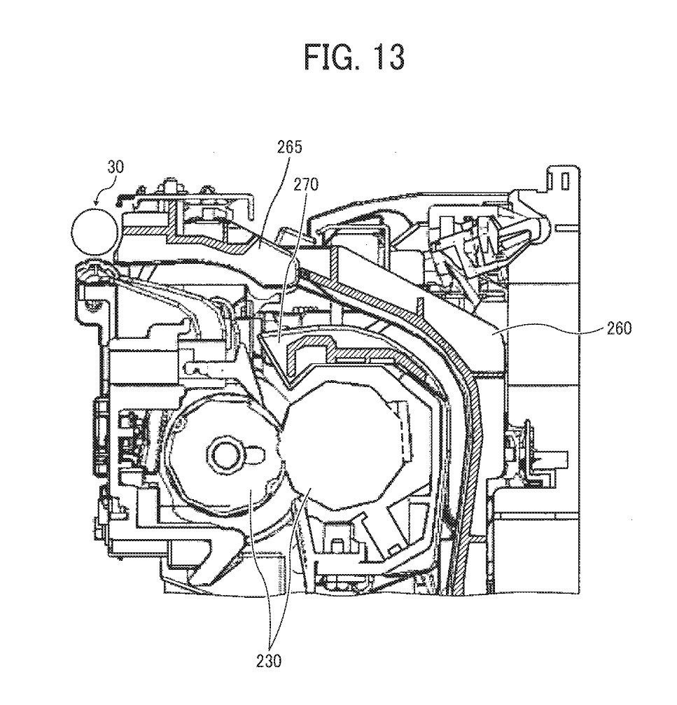

FIG. 16A is a perspective view illustrating a sheet transfer guide 270 that has the second sheet conveyance passage 252 and the third sheet conveyance passage 253. FIG. 16B is a cross sectional view illustrating the sheet transfer guide 270 of FIG. 16A. FIG. 16C is a cross sectional view illustrating a rib portion 271 of the sheet transfer guide 270 of FIG. 16A.

The sheet transfer guide 270 includes the rib portion 271 and guide faces 272 and 273. The rib portion 271 includes multiple projections extending in a sheet conveying direction D and a sheet conveying direction E. The multiple projections of the rib portion 271 are partially formed at predetermined intervals in the width direction of the sheet 400 perpendicular to the sheet conveying direction D and the sheet conveying direction E. The guide faces 272 and 273 are respective top surfaces of the rib portion 271 that contact the sheet 400. In other words, each of the guide faces 272 and 273 is a contact and slide portion with the sheet 400. Out of the two guide faces 272 and 273 including the top surfaces of the rib portion 271, the guide face 272 including the top surface extending in the sheet conveying direction D forms the second sheet conveyance passage 252 through which the sheet 400 that has passed the fixing section A is conveyed toward a nip region of the pair of sheet output rollers 30. Further, the guide face 272 has a flat shape in the sheet conveying direction D. The guide face 273 extending in the sheet conveying direction E forms the third sheet conveyance passage 253 through which the sheet 400 that has passed the fixing section A is conveyed toward the sheet reverse passage 254. The guide face 273 is warped outwardly to form a projection to fit to the curved surface of the sheet transfer guide 260 in the sheet conveying direction E.

Further, the guide faces 272 and 273 of the sheet transfer guide 270 that contacts the sheet 400 has a coat layer 271b, as described below. The coat layer 271b has a surface roughness Ra smaller than a surface roughness Ra of a base material 271a of the sheet transfer guide 270. Further, as described below, the difference Δμ of the static coefficient of friction μs and the kinetic coefficient of friction μd of the coat layer 271b is smaller than and equal to 0.12.

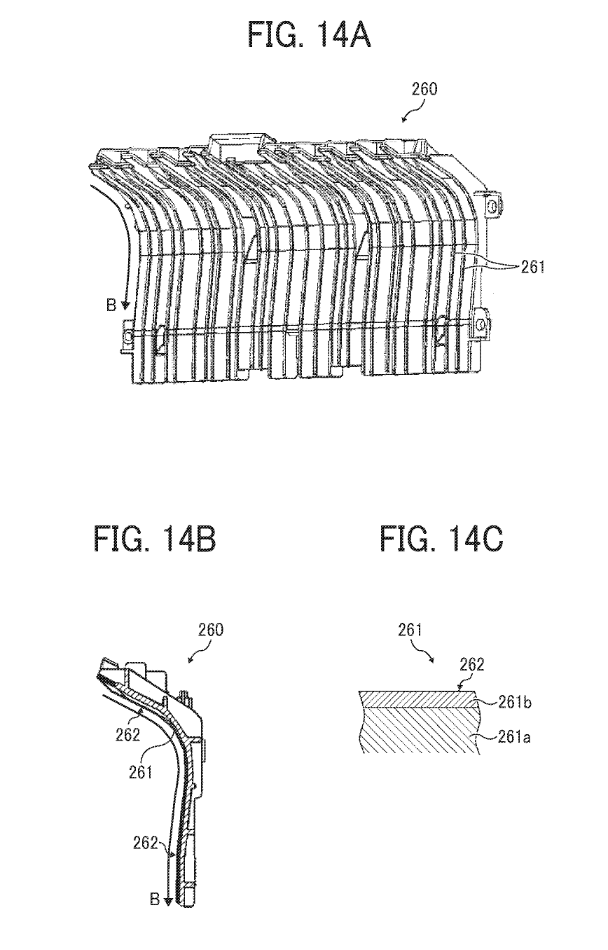

FIG. 17A is a perspective view illustrating the sheet transfer guide 340 that has the original document conveyance passage 330 provided to cause the original document 410 to pass through after having been fed from the ADF 310, toward the image reading position of the scanner 320. FIG. 17B is a cross sectional view illustrating the sheet transfer guide 340 of FIG. 17A. FIG. 17C is a cross sectional view illustrating a rib portion 341 of the sheet transfer guide 340 of FIG. 17A.

The sheet transfer guide 340 includes the rib portion 341 and a guide face 342. The rib portion 341 includes multiple projections extending in a document conveying direction F. The multiple projections of the rib portion 341 are partially formed at predetermined intervals in the width direction of the original document 410 perpendicular to the document conveying direction F. The guide face 342 is a top surface of the rib portion 341 that contacts the original document 410. In other words, the guide face 342 is a contact and slide portion with the original document 410. Further, the guide face 342 including the top surface of the rib portion 341 has a curved shape in the document conveying direction F.

Further, the guide face 342 of the sheet transfer guide 340 that contacts the original document 410 has a coat layer 341b. The coat layer 341b has a surface roughness Ra smaller than a surface roughness Ra of a base material 341a of the sheet transfer guide 340. Further, the difference μu of the static coefficient of friction μs and the kinetic coefficient of friction μd of the coat layer 341b is smaller than or equal to 0.12.

Table 2 indicates examples of materials including resin material and filler, which can be used for the base materials 261a, 266a, 271a, and 341a of the sheet transfer guides 260, 265, 270, and 340 provided to the image forming apparatus 100 according to the present embodiment of this disclosure.

TABLE 2

| Resin Materials | Symbol |
|---|---|
| 1 | ABS-FR(17) |
| 2 | PET-GF |
| 3 | PBT + ABS |
| 4 | PC + ABS-(TD + MD)5FR(40) |

“ABS-FR(17)” indicated as Resin Material 1 in Table 1 represents a flame retardant acrylonitrile-butadiene-styrene (ABS) resin to which a flame retardant of combination of an aromatic bromine compound and an antimony compound is added.
“PET-GF” indicated as Resin Material 2 in Table 1 represents a polyethylene terephthalate resin including glass fiber as a filler.
“PBT + ABS” indicated as Resin Material 3 in Table 1 represents an alloy of polybutylene terephthalate and ABS resin.
“PC + ABS-(TD + MD)5FR(40)” indicated as Resin Material 4 in Table 1 represents an alloy of polycarbonate and acrylonitrile-butadiene-styrene including talcum powder (TD) and mineral powder (MD) as a filler.

Resin Materials 1 through 4 may include carbon fiber as a filler. Resin Materials 1, 3, and 4 in Table 1 may include glass fiber as a filler.

Further, as described above, the guide face 262 of the sheet transfer guide 260 includes the coat layer 261b, the guide face 267 of the sheet transfer guide 265 includes the coat layer 266b, the guide faces 272 and 273 of the sheet transfer guide 270 include the coat layer 271b, and the guide face 342 of the sheet transfer guide 340 includes the coat layer 341b. These coat layers 261b, 266b, 271b, and 341b can be formed by applying a coat layer material to the guide faces 262, 267, 272 and 273, and 342, respectively. The coat layer material is a paste-like material generated by dispersing one or more known solid lubricants by any known application methods to a known binder resin containing adequate additives.

Examples of the solid lubricant are inorganic compounds such as molybdenum disulfide, tungsten disulfide, graphite, graphite fluoride, boron nitride, calcium fluoride, silicon dioxide, fullerene and carbon nanotube, soft metal system such as gold, silver, tin and copper, polymer system such as polytetrafluoroethylene (PTFE), fat such as metal soap and beeswax, solid ester, melamine cyanurate, and amino acid compounds.

Examples of the binder resin are acryl, epoxy, phenol, phthalic acid, polyamideimide, polyimide, silicon, PEEK, PTFE, and PFA.

Due to solidification of the coat layer materials applied onto the guide faces 262, 267, 272 and 273, and 342, the coat layers 261b, 266b, 271b, and 341b have the surface roughness Ra smaller than the base materials (base metals) 261a, 266a, 271a, and 341a. With the coat layers 261b, 266b, 271b, and 341b, the surface roughness on the guide face (i.e., the guide faces 262, 267, 272, 273, and 342) of each sheet transfer guide (i.e., the sheet transfer guides 260, 265, 270 and 340) to which the sheet contacts can be reduced, and therefore the sound of sheet conveyance occurred while guiding the sheet such as the sheet 400 and the original document 410 can be reduced.

The image forming apparatus according to the present embodiment has the above-described configuration in which conveyance of the sheet 400 is temporarily stopped while the leading end of the sheet 400 is abutting against the registration nip region of the pair of registration rollers 29 or when the sheet 400 is conveyed to the sheet reverse passage 254 using the switchback device. Further, the image reading device 300 temporarily stops before the original document 410 reaches the image reading position in the scanner 320. When the sheet 400 is conveyed again after the stop of conveyance of the sheet 400, the sheet 400 slips on the sheet transfer guides 260, 265, 270, and 340 to cause a slip stick phenomenon. As a result, it is likely that sliding sound (chattering noise) is generated.

In the present embodiment, the difference Δμ of the static coefficient of friction μs and the kinetic coefficient of friction μd of the coat layers 261b, 266b, 271b, and 341b is smaller than and equal to 0.12. Thus, a reduction in the difference Δμ of the static coefficient of friction and the kinetic coefficient of friction can restrain or prevent occurrence of the slip stick phenomenon, and therefore can restrain or prevent the sliding sound (chattering noise) from occurring when the sheet 400 is conveyed again.

Table 3 described below indicates results of a verification test. In the verification test, the sheet transfer guides 260, 265, and 270 with the respective coat layers 261b, 266b, and 271b having the difference Δμ of the static coefficient of friction μs and the kinetic coefficient of friction μd different from each other were attached to the image forming apparatus, and the sound generated when the sheet 400 is continuously conveyed in the same operation as the image forming operation was measured.

TABLE 3

| | | | | Noise Level |
|---|---|---|---|---|
| | μs | μd | Δμ | [dB] |
| Coat Layer A | 0.22 | 0.13 | 0.09 | 57.5 |
| Coat Layer B | 0.35 | 0.20 | 0.15 | 58.5 |
| Coat Layer C | 0.33 | 0.16 | 0.17 | 58.6 |
| Coat Layer D | 0.20 | 0.10 | 0.10 | 57.3 |
| Coat Layer E | 0.21 | 0.09 | 0.12 | 57.6 |

The static coefficient of friction μs and the kinetic coefficient of friction μd were measured by a friction coefficient measuring device (Surface Property Tester: HEIDON TYPE 14FW, pat. manufactured by Shinto Scientific Co., Ltd.). First, a roller having a coat layer formed thereon is set to the measuring device in a fixed (unrotatable) state and a sheet having a basis weight of 60 to 80 g/m2 is fixedly placed on a moving table of the measuring device. The roller is caused to slide on the sheet with the weight load of 400 gf at a table moving speed of 43 mm/sec. By so doing, the static coefficient of friction μs and the kinetic coefficient of friction μd are measured. The measurement was conducted in a standard environment (temperature: 23 degrees Celsius, humidity: 65%). The humidity of the roller and the humidity of the sheet used for the measurement are adjusted for greater than or equal to 4 hours. It is to be noted that each film thickness and surface roughness Ra of the coat layers A to E are equal to each other.

Further, the noise level [dB] is measured by extracting sound (frequency) related to sheet conveyance out of the entire sound generated by the image forming apparatus.

As can be seen from Table 2, the difference Δμ of the static coefficient of friction μs and the kinetic coefficient of friction μd of each of Coat Layers A, D and E is 0.12 or smaller, and reduces the noise level to 58 [dB] or smaller. Therefore, when compared with Coat Layers B and C have the difference Δμ of the static coefficient of friction μs and the kinetic coefficient of friction μd exceeding 0.12, Coat Layers A, D and E can lower the level of sound of sheet conveyance.

Further, by reducing of the static coefficient of friction μs and the kinetic coefficient of friction μd, occurrence of slip stick phenomenon can be reduced. Thus, it is preferable that the static coefficient of friction μs is reduced to 0.22 or smaller. According to this setting, after a reduction in the difference Δμ of the static coefficient of friction μs and the kinetic coefficient of friction μd, the difference Δμ of the static coefficient of friction μs and the kinetic coefficient of friction μd can be restrained to 0.12 or smaller. Accordingly, occurrence of the slip stick phenomenon can be further restrained.

It is to be noted that the above-described coat layer materials may be a material that can be applied to the guide faces 262, 267, 272, 273, and 342 of the sheet transfer guides 260, 265, 270, and 340, respectively, and may have the difference Δμ of the static coefficient of friction μs and the kinetic coefficient of friction μd set to 0.12 or smaller, in a solidified condition after application.

Further, each of the coat layers 261b, 266b, 271b, and 341b may be a layer that does not transfer to the sheet side even when the sheet such as the sheet 400 and the original document 410 contacts thereto. In this case, the functions of the coat layers 261b, 266b, 271b, and 341b can be maintained for a long period of time, and therefore the sound of sheet conveyance can also be reduced for a long period of time.

Further, each of the coat layers 261b, 266b, 271b, and 341b formed on the guide faces 262, 267, 272 and 273, and 342 of the sheet transfer guides 260, 265, 270, and 340 may have a film thickness equal to or smaller than 50 μm. Further, each of the coat layers 261b, 266b, 271b, and 341b may have a film thickness equal to 10 μm or greater.

Further, the surface roughness Ra of each of the coat layers 261b, 266b, 271b, and 341b may be equal to or smaller than 0.2 μm. The surface roughness Ra of each of the base materials (base metals) 261a, 266a, 271a, and 341a is equal to or greater than 0.2 μm and equal to or smaller than 3 μm.

Next, a description is given of a method of forming a coat layer to the guide face of each of the sheet transfer guides provided to the image forming apparatus 100.

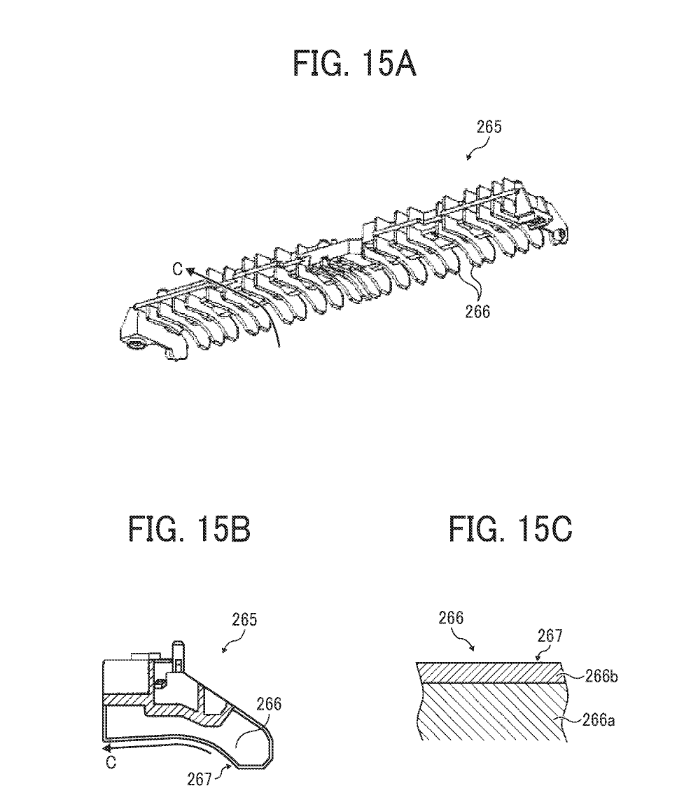

FIG. 18 is a diagram illustrating an application device 500 used for manufacturing the sheet transfer guide 260 according to an embodiment of this disclosure.

In FIG. 18, the application device 500 applies liquid type coat layer material to the guide face 262 of the sheet transfer guide 260 that defines the third sheet conveyance passage 253. It is to be noted that a target of applying the coat layer material in the application device 500 is not limited to the sheet transfer guide 260 but may be the sheet transfer guides 265, 270 or 340.

The application device 500 illustrated in FIG. 18 includes a liquid spray type application device. The application device 500 includes a tank 502, a hose (or a pipe) 503, and a liquid spray portion 504. The tank 502 contains coating liquid 501 that is a liquid type coat layer material. The hose (pipe) 503 functions as a liquid supply passage forming body. The liquid spray portion 504 that is coupled with the tank 502 via the hose 503. Further, the application device 500 includes a holding mechanism that is movable while holding the sheet transfer guide 260. The sheet transfer guide 260 is held by the holding mechanism such that the guide face 262 of the sheet transfer guide 260 is disposed facing the liquid spray portion 504.

The liquid spray portion 504 includes a pump and a nozzle. The pump is a controllable pump that presses coating liquid supplied from the tank 502. The nozzle injects the pressed coating liquid radially. The liquid spray portion 504 is rotatable in a direction indicated by arrow G by a controllable rotary drive portion 505.

The holding mechanism includes a holding portion 506, a rotary drive portion 507, and a slide drive portion 508. The holding portion 506 holds the sheet transfer guide 260. The rotary drive portion 507 is controllable to slide the holding portion 506 while supporting and driving the holding portion 506. The rotary drive portion 507 can rotate in a direction indicated by arrow H while supporting the holding portion 506. The slide drive portion 508 can slide the rotary drive portion 507 while supporting the rotary drive portion 507. The rotation and sliding movement are controlled to cause an angle of injection direction of an injecting portion to the guide face 262 when a position of application on the guide face 262 is changed, for example.

The rotary drive portion 505 and the rotary drive portion 507 may include, for example, drive transmission components such as motors and gears, and drive shaft members. Further, the slide drive portion 508 may include, for example, a slide guide portion, a movable portion that is guided by the slide guide portion, and a slide drive unit that drives the movable portion. The slide drive unit may include, for example, a belt drive method, a rack and pinion method, and a linear motor method.

The pump of the liquid spray portion 504, the rotary drive portion 505, and the rotary drive portion 507 and the slide drive portion 508 of the holding mechanism are controlled by a controller that includes a central processing unit (CPU), based on a predetermined control program.

In the application device 500 having the above-described configuration, the sheet transfer guide 260 that is held by the holding mechanism can be slid while being rotated in a predetermined direction and the liquid spray portion 504 can inject coating liquid while being rotated. Accordingly, even when the guide face 262 of the sheet transfer guide 260 is warped as illustrated in FIG. 18, the coating liquid can be uniformly applied to the guide face 262 having the optional warped shape, so that the coat layer 261b having a uniform film thickness can be formed, as illustrated in FIG. 14C

It is to be noted that the application device 500 illustrated in FIG. 18 causes the sheet transfer guide 260 to slide. However, the configuration of the application device 500 is not limited thereto. For example, the liquid spray portion 504 can be slid instead of the sheet transfer guide 260 or together with the sheet transfer guide 260.

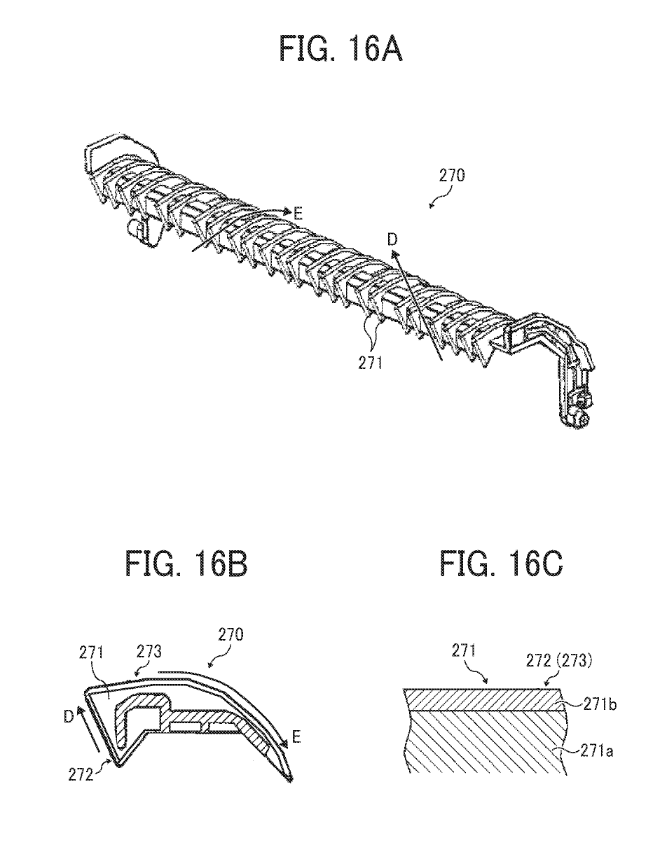

FIG. 19 is a diagram illustrating another application device used for manufacturing the sheet transfer guide according to an embodiment of this disclosure.

In FIG. 19, an application device 510 applies liquid type coat layer material to the guide face 267 of the sheet transfer guide 265 that defines the second sheet conveyance passage 252. It is to be noted that a target of applying the coat layer material in the application device 510 is not limited to the sheet transfer guide 265 but may be the sheet transfer guide 260, 270, or 340.

The application device 510 illustrated in FIG. 19 includes an application roller type application device. The application device 510 includes an application roller 511 has a surface that is formed by material such as sponge, rubber, non-woven cloth, and felted fabric to which coating liquid that is liquid coat layer material is soaked. The application roller 511 rotates in a direction indicated by arrow J in FIG. 19 and slides in a direction indicated by arrow K and in a direction indicated by arrow L in FIG. 19. The direction K and the direction L are perpendicular to each other. The slide drive portion that causes the application roller 511 to slide is controlled by the controller that includes the CPU, based on a predetermined control program. It is to be noted that the application roller 511 may be rotated with movement of the guide face 267 of the sheet transfer guide 265 or may be rotated by the rotary drive portion.

The rotary drive portion may include, for example, drive transmission components such as motors and gears, and drive shaft members. Further, the slide drive portion may include, for example, a slide guide portion, a movable portion that is guided by the slide guide portion, and a slide drive unit that drives the movable portion. The slide drive unit may include, for example, a belt drive method, a rack and pinion method, and a linear motor method.

In the application device 510 having the above-described configuration, the application roller 511 slides in the direction K and the direction L so that the application roller 511 contacts the guide face 267 of the sheet transfer guide 265. Accordingly, even when the guide face 267 of the sheet transfer guide 265 is warped as illustrated in FIG. 19, the coating liquid can be uniformly applied to the guide face 267 having the optional warped shape, so that the coat layer 266b having a uniform film thickness can be formed, as illustrated in FIG. 15C.

It is to be noted that the application device 510 illustrated in FIG. 19 causes the application roller 511 to slide. However, the configuration of the application device 510 is not limited thereto. For example, the sheet transfer guide 265 can be slid instead of the application roller 511 or together with the application roller 511.

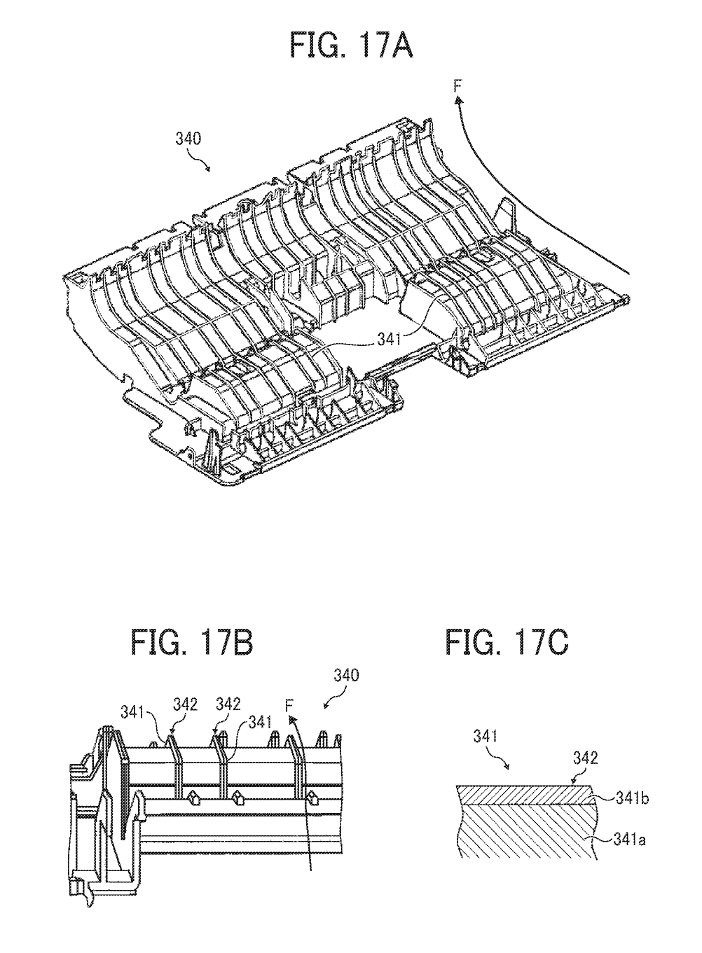

FIG. 20 is a diagram illustrating yet another application device used for manufacturing the sheet transfer guide according to an embodiment of this disclosure.

In FIG. 20, an application device 520 applies liquid type coat layer material to the guide face 342 of the sheet transfer guide 340 that defines the original document conveyance passage 330. It is to be noted that a target of applying the coat layer material in the application device 520 is not limited to the sheet transfer guide 340 but may be the sheet transfer guide 260, 265, or 270.

The application device 520 illustrated in FIG. 20 includes a liquid spray type application device, which is the same configuration as the application device 500 illustrated in FIG. 18. It is to be noted that elements or components of the application device 520 may be denoted by the same reference numerals as those of the application device 500, and the descriptions thereof are omitted or summarized.

In FIG. 20, the application device 520 includes a holding mechanism that holds the sheet transfer guide 340 so that the guide faces 342 of the sheet transfer guide 340 are disposed facing the liquid spray portion 504. Further, except the guide faces 342, any possible areas to which coating liquid to be injected by the liquid spray portion 504 on the surface of the sheet transfer guide 340 are covered by covers 525. With the covers 525, the coating liquid is not applied to the unneeded surface of the sheet transfer guide 340, other than the guide faces 342. Therefore, failure such as dripping of coating liquid to unneeded surface of the sheet transfer guide face 342 can be avoided.

The liquid spray portion 504 is rotatable in a direction in a direction indicated by arrow M by a rotary drive portion 521 that is controllable. The rotary drive portion 521 can slide in a direction indicated by N while being supported by a slide drive portion 522. The pump of the liquid spray portion 504, the rotary drive portion 521, and the rotary drive portion 521 are controlled by the controller that includes the CPU, based on the predetermined control program.

The rotary drive portion 521 may include, for example, drive transmission components such as motors and gears, and drive shaft members. Further, the slide drive portion 522 may include, for example, a slide guide portion, a movable portion that is guided by the slide guide portion, and a slide drive unit that drives the movable portion. The slide drive unit may include, for example, a belt drive method, a rack and pinion method, and a linear motor method.

In the application device 520 having the above-described configuration, the liquid spray portion 504 can inject coating liquid while being slid and rotated. Accordingly, the coating liquid can be uniformly applied to the entire guide face 342 of the sheet transfer guide 340, so that the coat layer 341b having a uniform film thickness can be formed, as illustrated in FIG. 17C.

It is to be noted that the application device 520 illustrated in FIG. 20 causes the liquid spray portion 504 to slide. However, the configuration of the application device 520 is not limited thereto. For example, the sheet transfer guide 340 can be slid instead of the liquid spray portion 504 or together with the liquid spray portion 504.

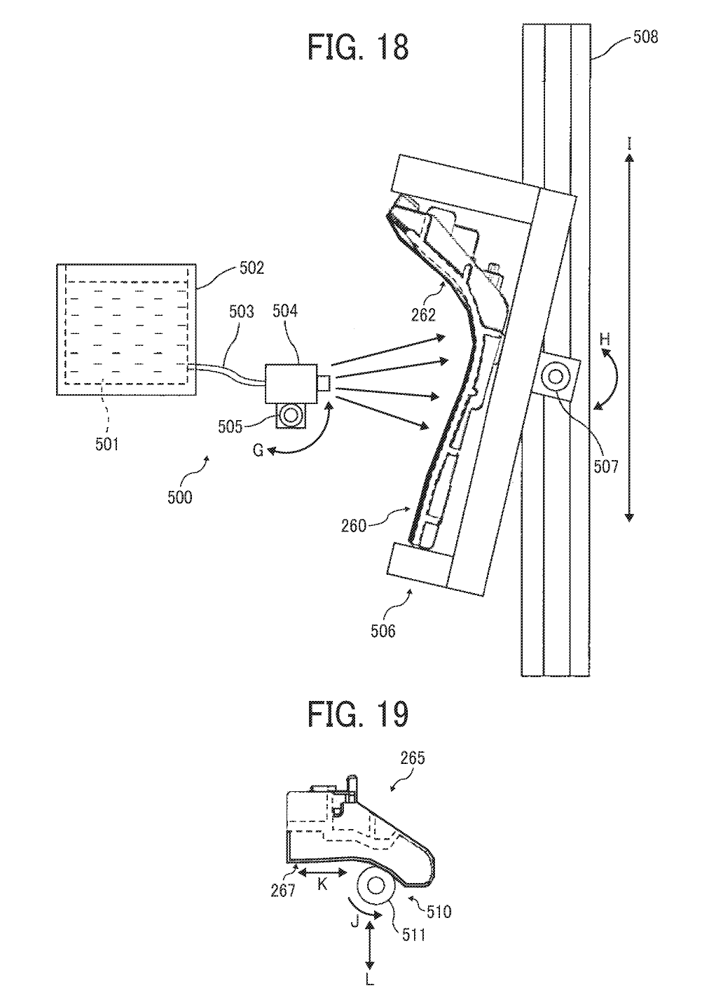

FIG. 21A is a plan view illustrating yet another application device used for manufacturing the sheet transfer guide according to an embodiment of this disclosure. FIG. 21B is a front view illustrating the application device of FIG. 21A. It is to be noted that elements or components of an application device 530 may be denoted by the same reference numerals as those of the application device 500, and the descriptions thereof are omitted or summarized.

In FIGS. 21A and 21B, an application device 530 applies liquid type coat layer material to the guide faces 272 and 273 of the sheet transfer guide 270 that define the second sheet conveyance passage 252 and the third sheet conveyance passage 253. It is to be noted that a target of applying the coat layer material in the application device 530 is not limited to the sheet transfer guide 270 but may be the sheet transfer guide 260, 265, or 340.

The application device 530 illustrated in FIGS. 21A and 21B includes an inkjet type application device. The application device 530 includes a droplet discharging head 531 and a head moving device. The droplet discharging head 531 includes multiple nozzles 531a aligned in a row or in multiple rows. The head moving device moves the droplet discharging head 531. The droplet discharging head 531 is provided with liquid chambers. Each of the liquid chambers is provided to each of multiple nozzles 531a and is pressed by a piezoelectric element at an optional timing. Coating liquid is supplied from the tank 502 to each liquid chamber.

The sheet transfer guide 270 is set on a stage 533 such that the guide faces 272 and 273 are disposed facing the nozzles 531a of the droplet discharging head 531.

The head moving device includes a support arm 532 and a pair of slide drive units 534. The support arm 532 supports the droplet discharging head 531. The pair of slide drive units 534 includes rails 534a and slides to move the support arm 532 along the rails 534a while guiding the support arm 532 in a direction indicated by arrow O in FIG. 21A on the stage 533.

The discharge of droplets of coating liquid from each nozzle 531a of the droplet discharging head 531 and the pair of slide drive units 534 are controlled by the controller that includes the CPU, based on the predetermined control program. Here, the discharge of droplets of coating liquid from each nozzle 531a of the droplet discharging head 531 may alternatively be controlled by the controller such that the coating liquid is applied to the guide face of the sheet transfer guide 270 alone.

The slide drive unit that drives the support arm 532 by the pair of slide drive units 534 may include, for example, a belt drive method, a rack and pinion method, and a linear motor method.

In the application device 530 having the above-described configuration, the droplet discharging head 531 discharges droplets of the coating liquid from the droplet discharging head 531 while the droplet discharging head 531 that is supported by the support arm 532 is moving in the direction O in FIG. 21A. Accordingly, the coating liquid can be uniformly applied to the guide faces 272 and 273 having the optional shapes of the sheet transfer guide 270, so that the coat layer 271b having a uniform film thickness can be formed, as illustrated in FIG. 16C.

It is to be noted that the application device 530 illustrated in FIGS. 21A and 21B causes the droplet discharging head 531 to slide. However, the configuration of the application device 530 is not limited thereto. For example, the sheet transfer guide 270 can be slid instead of the droplet discharging head 531 or together with the droplet discharging head 531.

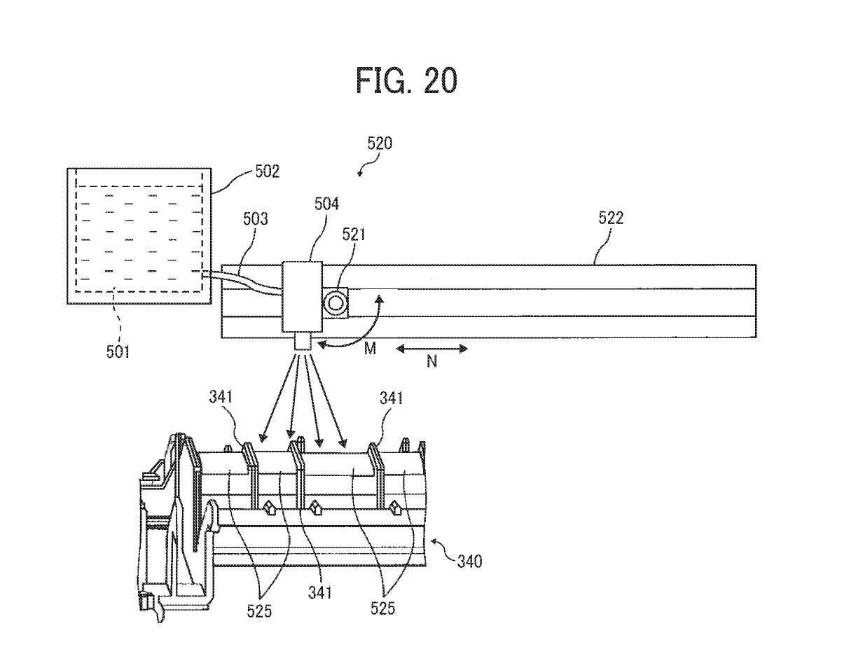

FIG. 22 is a perspective view illustrating opening and closing of a cover 201 and a bypass tray 202.

As illustrated in FIG. 22, the cover 201 is disposed at the front of the apparatus body 200. The cover 201 is opened and closed when the image forming units 6Y, 6M, 6C, and 6K are replaced. In addition, the bypass tray 202 is disposed openably and closably on one side of apparatus body 200. The cover 201 of the apparatus body 200 of the image forming apparatus 100 is rotatably supported by a support shaft 201a thereof. The cover 201 is rotated about the support shaft 201a to open from the apparatus body 200 of the image forming apparatus 100 from the closed position illustrated in FIG. 22 in the direction indicated by arrow F in FIG. 22.

Further, the bypass tray 202 is also rotatably supported by a support shaft 202a thereof. The bypass tray 202 is rotated about the support shaft 202a to open from the apparatus body 200 of the image forming apparatus 100 from the closed position illustrated in FIG. 22 in the direction indicated by arrow G in FIG. 22. The cover 201 and the bypass tray 202 are made of resin material. The support shaft 201a of the cover 201 and the support shaft 202a of the bypass tray 202 are made of metal or resin material.

When opening and closing the cover 201 or the bypass tray 202, the cover 201 and the bypass tray 202 slide about the support shaft 201a and the support shaft 202a, respectively. Therefore, when the cover 201 and the bypass tray 202 are opened from the closed position or closed from the open position, slip stick phenomenon is generated, and it is likely to cause a sliding sound.

Accordingly, it is preferable to form the above-described coat layer on respective sliding surfaces (contact and slide portions) sliding relative to the support shaft 201a of the cover 201 and the support shaft 202a of the bypass tray 202 or on respective outer circumferential surfaces (contact and slide portions) of the support shaft 201a of the cover 201 and the support shaft 202a of the bypass tray 202. Consequently, when opening and closing the cover 201 and the bypass tray 202, occurrence of the sliding sound can be prevented.

As illustrated in FIG. 1, a top cover 203 is provided on the top surface of the apparatus body 200 of the image forming apparatus 100. The top cover 203 is opened and closed when the toner bottles 32Y, 32M, 32C, and 32K are replaced. The top cover 203 is rotatably supported by a support shaft 203a thereof. Accordingly, it is also preferable to form the above-described coat layer on a sliding surface (a contact and slide portion) relative to the support shaft 203a of the top cover 203 or on an outer circumferential surface (a contact and slide portion) of the support shaft 203a of the top cover 203.

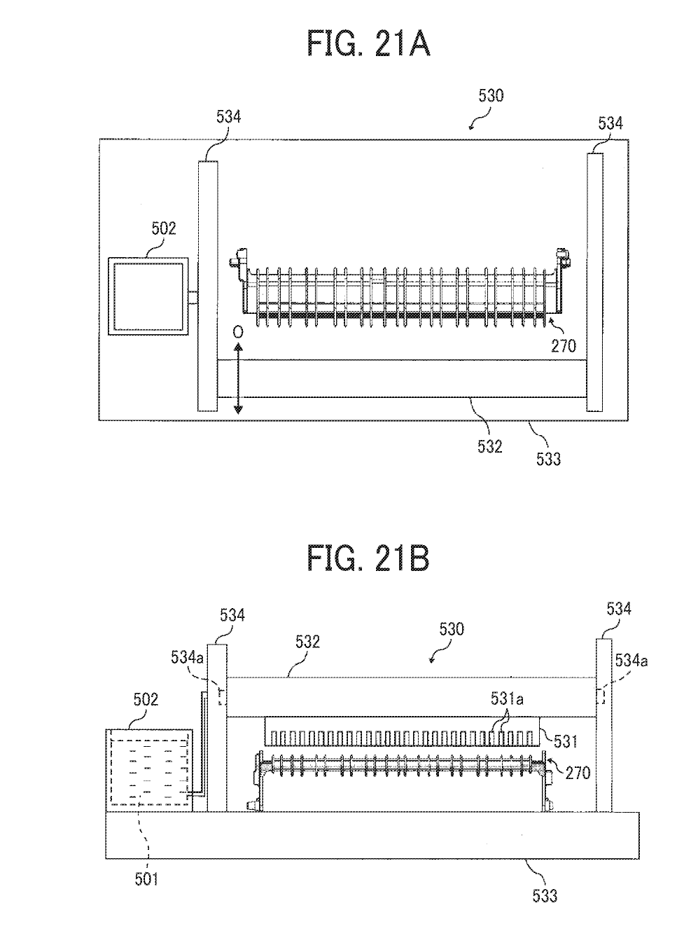

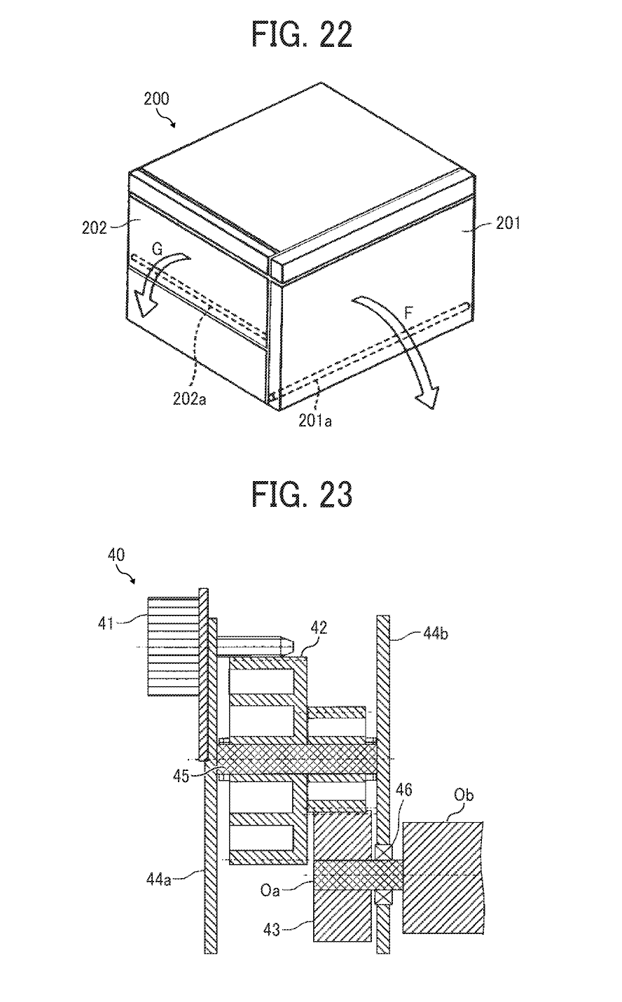

FIG. 23 is a diagram illustrating a drive device 40 provided to the apparatus body 200 to rotate a rotary body such as a photoconductor. FIG. 24 is a front view illustrating a step gear 42.

The drive device 40 illustrated in FIG. 23 includes a fixed shaft 45 and the step gear 42. The fixed shaft 45 is a metallic shaft fixed to a pair of side frames 44a and 44b disposed facing each other. The step gear 42 is made of resin and is rotatably supported by the fixed shaft 45. The driving force applied by a drive motor 41 is transmitted via the step gear 42 to a drive gear 43 mounted on a shaft Oa of a rotary body Ob. Accordingly, the rotary body Ob rotates. When the driving force is transmitted to the rotary body Ob, the step gear 42 slides on the fixed shaft 45. Therefore, when the drive device 40 is driven, slip stick phenomenon is generated, and it is likely to cause a sliding sound. Accordingly, as illustrated in FIG. 24, it is preferable to form the above-described coat layer on an inner circumferential surface (a contact and slide portion) of a through hole 42a of the step gear 42. The fixed shaft 45 is inserted into the through hole 42a while sliding on the through hole 42a. Accordingly, occurrence of the noise caused by the sliding sound at the start of the drive device 40 can be prevented or restrained. The above-described coat layer may be formed not on the inner circumferential surface of the through hole 42a but on the fixed shaft 45.

Further, a bearing 46 that receives the shaft Oa of the rotary body Ob is made of resin material and swings about the shaft Oa of the rotary body Ob. Therefore, by forming the coat layer on the inner circumferential surface (a contact and slide portion) of the through hole 42a and/or a sliding surface (a contact and slide portion) of the bearing 46, on which the shaft Oa of the rotary body Ob contacts and slides, the sliding sound can be reduced.

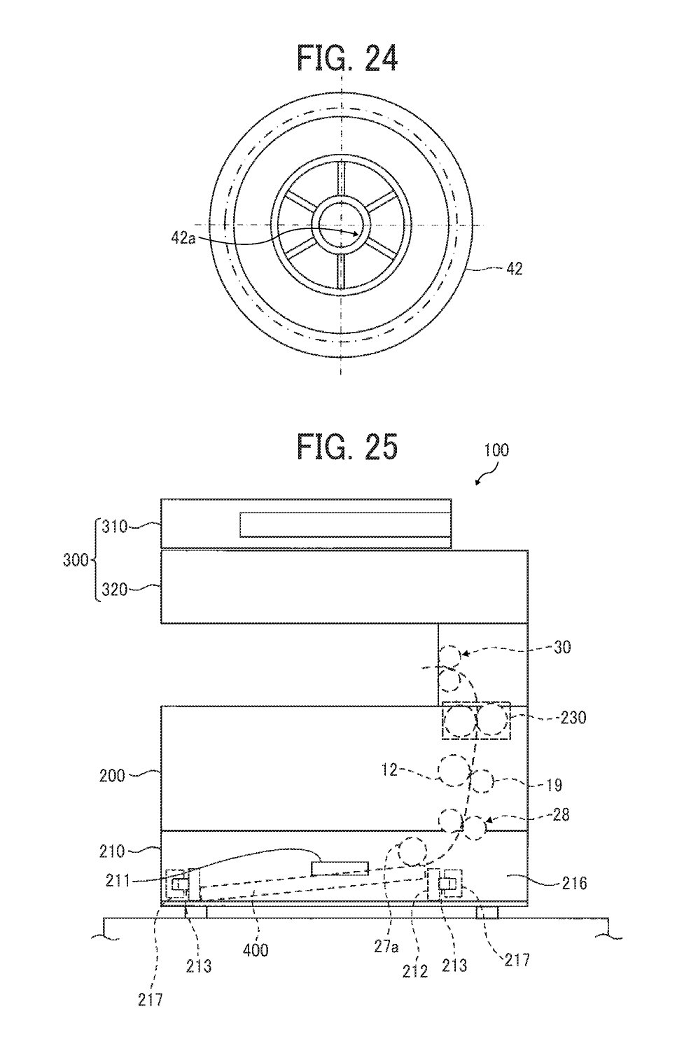

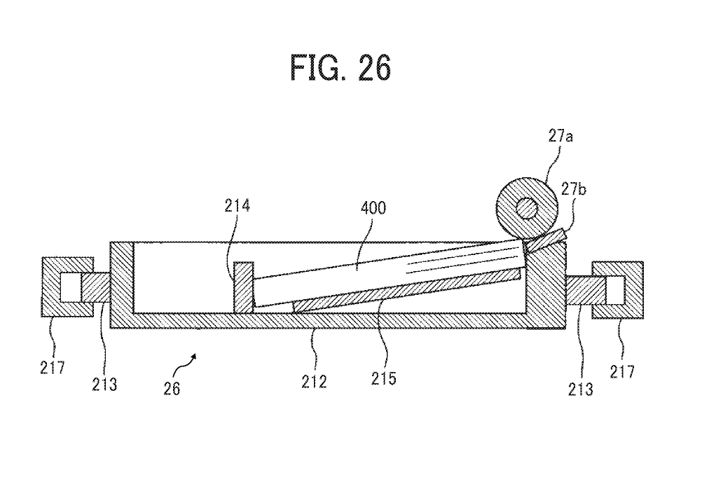

FIG. 25 is a diagram illustrating rollers that apply a transfer force to the sheet 400 and the sheet container 26 in the image forming apparatus 100. FIG. 26 is a diagram illustrating the sheet container 26.

The sheet container 26 includes a container body 212, guides 213, an end fence 214, side fences, a lifting base plate 215, a container exterior cover 216 and a handle 211. The container body 212 includes a box-shaped resin material with an open top. The container body 212 forms a sheet containing space inside which the sheet 400 is contained. The guides 213 that include resin material are provided to a right side plate and a left side plate of the container body 212, as illustrated in FIGS. 25 and 26. Guide rails 217 that are made of metal are provided to the sheet feeding device 210. When the sheet container 26 is attached to the sheet container 26, the guides 213 guide the sheet container 26 to move along the respective guide rails 217.

The guides 213 slide on the respective guide rails 217 when a user grabs the handle 211 to pull from or put in the sheet feeding device 210. Therefore, when the sheet container 26 is installed in or removed from the sheet feeding device 210, it is likely that slip stick phenomenon occurs to cause a sliding sound. Accordingly, it is preferable to form the above-described coat layer on upper and lower faces (contact and slide portions) of the guides 213 that slide on the guide rails 217 or a sliding face (a contact and slide portion) of the guide rails 217 along which the guides 213 contact and slide. Therefore, when the sheet container 26 is installed in or removed from the sheet feeding device 210, occurrence of the sliding sound can be restrained.

It is to be noted that the above-described configuration is an example. For example, in an image forming apparatus, the above-described coat layer may be formed on a sliding surface of a member on which a contacting member contacts and slides. For example, the above-described coat layer may be formed on a cleaning blade that cleans the surface of the photoconductor while sliding on the photoconductor or on a leading end of the cleaning blade that cleans the surface of the intermediate transfer belt, to which the contacting member contacts. Further, as described in a comparative configuration, a fixing device includes a nip forming member provided inside an endless fixing belt and a pressure roller contacting the nip forming member via the endless fixing belt, so that a fixing nip region is formed between the nip forming member and the pressure roller. In this configuration, the above-described coat layer may be formed on a sliding surface of the nip forming member contacting the fixing belt.

Further, this disclosure is applicable to an image reading device without an automatic document feeder attached. In such image reading device, when reading an image formed on an original document set on an exposure glass, a carriage on which a light source to emit light onto a document surface is mounted is moved along the document surface of the original document. At this time, the carriage slides on a guide to guide the carriage, and therefore it is likely to generate a sliding sound. Accordingly, by forming the above-described coat layer on a guide target member of the carriage that is guided by the guide or a portion of the guide on which the carriage slides, the noise generated by the image reading device without the automatic document feeder can be restrained.

The configurations according to the above-descried embodiments are not limited thereto. This disclosure can achieve the following aspects effectively.

Aspect 1.

In Aspect 1, a detector (for example, the detectors 282, 292,222, 351,361) contacting and detecting a sheet (for example, the sheet 400, the original document 410, the detector includes a base (for example, the base materials 282g,292g,222g), a sheet contact face (for example, the sheet contact faces 282s,292s,222s) to which the sheet contacts, and a coat layer (for example, the coat layers 282b,292b,222b) formed on the sheet contact face.

According to this configuration, as described in the above-described embodiments, the coat layer, which is formed on the sheet contact face of the detector to which the sheet contacts, can be maintained from the friction with the sheet, and therefore the wear of the detector generated where the detector contacts the sheet can be reduced.

Aspect 2.

In Aspect 1, the coat layer has a film thickness equal to or less than 50 μm.

According to this configuration, as described in the above-described embodiments, even when the coat layer having the film thickness of 50 μm or smaller is provided to the detector, a small effect is given to the detection property to detect whether the sheet passes or not or whether the sheet is present or not. Therefore, the detection property can be maintained without changing the dimensions of the base material of the detector. Specifically, in a case in which the thickness of a target sheet to be conveyed is approximately 100 μm (for example, 100 μm±10 μm) or greater, the film thickness of the coat layer is equal to or smaller than a half of the thickness of the sheet. Therefore, according to this configuration, the detection property can be maintained reliably without changing the dimensions of the base material of the detector.

Aspect 3.

In Aspect 1 or Aspect 2, the coat layer has a film thickness equal to or greater than 20 μm.

According to this configuration, as described in the above-described embodiments, the effective function of the coat layer to protect from the friction with the sheet can be achieved reliably.

Aspect 4.

In any one of Aspect 1 through Aspect 3, the coat layer does not move to the sheet in response to a contact with the sheet.

According to this configuration, as described in the above-described embodiments, the effective function of the coat layer to protect the detector can be maintained for a long period of time. Therefore, the wear on the detector generated where the detector contacts the sheet can be reduced for a long period of time.

Aspect 5.

In any one of Aspect 1 through Aspect 4, the coat layer has a surface roughness smaller than a surface roughness of the base (for example, the base materials 282g, 292g, 222g).

According to this configuration, as described in the above-described embodiments, even though the base is not processed to reduce the surface roughness, the surface roughness of the sheet contact face is reduced to reduce the friction with the sheet. Therefore, the wear of the coat layer and the damage on the sheet can be reduced.

Aspect 6.

In Aspect 5, the surface roughness Ra of the coat layer is equal to or smaller than 0.2 μm and the surface roughness Ra of the base is equal to or greater than 0.2 μm and equal to or smaller than 3 μm.

According to this configuration, as described in the above-described embodiments, the wear of the coat layer and the damage on the sheet can be reduced reliably for a long period of time, and therefore the manufacturing of the base can be easier and the manufacturing cost can be reduced.

Aspect 7.

In any one of Aspect 1 through Aspect 6, a coefficient of friction of the coat layer to the sheet is smaller than a coefficient of friction of the base to the sheet.

According to this configuration, as described in the above-described embodiments, even though the base is not processed to reduce the coefficient of friction, the coefficient of friction of the sheet contact face can be reduced. Therefore, the wear of the coat layer and the damage on the sheet can be reduced.

Aspect 8.

In any one of Aspect 1 through Aspect 7, the coat layer includes a resin containing a solid lubricant.

According to this configuration, as described in the above-described embodiment, relatively easy processes to apply resin including a solid lubricant onto the surface of the base of the detector and to dry and harden the resin are taken. Accordingly, the coat layer having a function to protect the detector from friction of the sheet can be provided.

Aspect 9.

In any one of Aspect 1 through Aspect 8, the base includes resin.

According to this configuration, as described in the above-described embodiments, the base of the detector can be molded easily, and therefore a high degree of freedom can be achieved in selection of materials of the coat layer.

Aspect 10.

In Aspect 9, the base includes at least resin and reinforced fiber.

According to this configuration, as described in the above-described embodiments, the rigidity and heat resistance of the detector can be enhanced. Further, by including the reinforced fiber, even when the surface roughness of the base increases, the coat layer coat layer is formed on the sheet contact face of the base, and therefore the friction of the detector applied to the sheet contact face of the detector can be reduced.

Aspect 11.

In any one of Aspect 1 through Aspect 10, the detector further includes a rotary shaft (for example, the rotary shafts 282c and 292c) rotatably supported and configured to rotate according to passing of the sheet (for example, the sheet 400) in a sheet conveyance passage (for example, the third sheet conveyance passage 253 and the fifth sheet conveyance passage 255).

According to this configuration, as described in the above-described embodiments, the friction at the sheet contact face of the detector that rotates according to passing or no passing of the sheet is reduced, and therefore the accuracy in detection of the passing of the sheet can be maintained.

Aspect 12.

In any one of Aspect 1 through Aspect 10, the detector further includes a rotary shaft (for example, the rotary shaft 222c) rotatably supported and configured to rotate according to presence of the sheet (for example, the sheet 400 and the original document 410) in a sheet container (for example, the sheet feeding device 210 and the original document loading table 311).

According to this configuration, as described in the above-described embodiments, the friction at the sheet contact face of the detector that rotates according to presence or absence of the sheet is reduced, and therefore the accuracy in detection of the presence of the sheet can be maintained.

Aspect 13.

In Aspect 13, a sheet conveying device (for example, the sheet conveying device 250) includes a conveyance passage forming body (for example, the sheet transfer guides 265, the inner conveyance guide 275, the outer conveyance guide 276) configured to define a sheet conveyance passage (for example, the first sheet conveyance passage 251, the second sheet conveyance passage 252, the third sheet conveyance passage 253, the fourth sheet conveyance passage 254, the fifth sheet conveyance passage 255), a sheet conveying body (for example, the pair of sheet output rollers 30, the pair of sheet conveying rollers 28, the pair of registration rollers 29, and the secondary transfer roller 19) configured to convey a sheet (for example, the sheet 400) through the sheet conveyance passage, the detector according to Aspect 11 (for example, the detectors 282 and 292) configured to contact the sheet while the sheet is being conveyed through the sheet conveyance passage, and a rotary detector (for example, the optical sensors 284 and 294) configured to detect rotation of the detector.

According to this configuration, as described in the above-described embodiments, the friction at the sheet contact face of the detector that rotates according to passing or no passing of the sheet in the sheet conveyance passage of the sheet conveying device is reduced, and therefore the accuracy in detection of the passing of the sheet can be maintained.

Aspect 14.

In Aspect 14, a sheet feeding device (for example, the sheet feeding device 210 and the ADF 310) includes a sheet container (for example, the sheet container 26 and the original document loading table 311) configured to contain a sheet (for example, the sheet 400 and the original document 410), the detector according to claim Aspect 12 (for example, the detectors 222, 351, 361) configured to contact and detect the sheet contained in the sheet container, and a rotary detector (for example, the optical sensors 224, 350, 362) configured to detect rotation of the detector.

According to this configuration, as described in the above-described embodiments, the friction at the sheet contact face of the detector that rotates according to presence or absence of the sheet is reduced, and therefore the accuracy in detection of the presence of the sheet can be maintained.

Aspect 15.

In Aspect 15, an image forming apparatus (for example, the image forming apparatus 100) includes a conveyance passage forming body (for example, the sheet transfer guides 265, the inner conveyance guide 275, the outer conveyance guide 276) configured to define a sheet conveyance passage (for example, the first sheet conveyance passage 251, the second sheet conveyance passage 252, the third sheet conveyance passage 253, the fourth sheet conveyance passage 254, the fifth sheet conveyance passage 255), a sheet conveying body (for example, the pair of sheet output rollers 30, the pair of sheet conveying rollers 28, the pair of registration rollers 29, and the secondary transfer roller 19) configured to convey a sheet (for example, the sheet 400) through the sheet conveyance passage, the detector according to Aspect 11 (for example, the detectors 282 and 292) configured to contact the sheet while the sheet is passing through the sheet conveyance passage, a rotary detector (for example, the optical sensors 284 and 294) configured to detect rotation of the detector, and an image forming device (for example, the image forming units 6Y, 6M, 6C, and 6K) configured to form an image on the sheet.

According to this configuration, as described in the above-described embodiments, the friction at the sheet contact face of the detector that rotates according to passing or no passing of the sheet in the sheet conveyance passage of the image forming apparatus is reduced, and therefore the accuracy in detection of the passing of the sheet can be maintained.

Aspect 16.

In any one of Aspect 1 through Aspect 15, an image forming apparatus (for example, the image forming apparatus 100) includes a sheet container (for example, the sheet container 26 and the original document loading table 311) configured to contain a sheet (for example, the sheet 400 and the original document 410), the detector according to claim Aspect 12 (for example, the detectors 222, 351, 361) configured to contact and detect the sheet contained in the sheet container, a rotary detector (for example, the optical sensors 224, 350, 362) configured to detect rotation of the detector, an image forming device (for example, the image forming units 6Y, 6M, 6C, and 6K) configured to form an image on the sheet.

According to this configuration, as described in the above-described embodiments, the friction at the sheet contact face of the detector that rotates according to presence or absence of the sheet in the sheet container of the image forming apparatus is reduced, and therefore the accuracy in detection of the presence of the sheet can be maintained.

Aspect 17.

In Aspect 17, an image reading device (for example, the image reading device 300) includes a conveyance passage forming body (for example, the guide face 342) configured to define a sheet conveyance passage (for example, the original document conveyance passage 330), a sheet conveying body (for example, the multiple pairs of document conveying rollers 363-368) configured to convey a sheet (for example, the original document 410) through the sheet conveyance passage, the detector according to Aspect 11 (for example, the detectors 351 and 361) configured to contact the sheet while the sheet is passing through the sheet conveyance passage, a rotary detector (for example, the original document sensors 350 and 362) configured to detect rotation of the detector, and an image reader (for example, the scanner 320) configured to read an image formed on the sheet.

According to this configuration, as described in the above-described embodiments, the friction at the sheet contact face of the detector that rotates according to passing or no passing of the sheet in the sheet conveyance passage of the image reading device is reduced, and therefore the accuracy in detection of the passing of the sheet can be maintained.

Aspect 18.

In Aspect 18, an image reading device (for example, the image reading device 300) includes a sheet container (for example, the original document loading table 311) configured to contain a sheet (for example, the original document 410), the detector according to claim Aspect 12 (for example, the detectors 351, 361) configured to contact and detect the sheet contained in the sheet container, a rotary detector (for example, the optical sensors 350, 362) configured to detect rotation of the detector, an image reader (for example, the scanner 320) configured to read an image formed on the sheet.

According to this configuration, as described in the above-described embodiments, the friction at the sheet contact face of the detector that rotates according to presence or absence of the sheet in the sheet container of the image reading device is reduced, and therefore the accuracy in detection of the presence of the sheet can be maintained.

Aspect 19.

In Aspect 19, a member (for example, the sheet transfer guides 260, 265, 270, and 340) used in either one of an image forming apparatus (for example, the image forming apparatus 100), an image reading device (for example, the image reading device 300) and an automatic document feeder (for example, the ADF 310) includes a base (for example, the base materials 261a, 266a, 271a, 341a) and a coat layer (for example, the coat layers 261b, 266b, 271b, and 341b). A difference Δμ of a static coefficient of friction μs of the coat layer and a kinetic coefficient of friction μd of the coat layer is smaller than and equal to 0.12.

According to this configuration, as described in the test, occurrence of the slip stick phenomenon can be restrained or prevented, and therefore the sliding sound (chattering noise) is restrained or prevented from occurring. Accordingly, the sound (noise) generated by the image forming apparatus and the image reading device can be restrained or prevented.

Aspect 20.

In Aspect 19, the coat layer has the static coefficient of friction μs equal to or smaller than 0.22.

According to this configuration, as described in the embodiments above, after the static coefficient of friction μs and the kinetic coefficient of friction μd are reduced, a reduction in the difference Δμ of the static coefficient of friction μs and the kinetic coefficient of friction μd can be restrained to 0.12 or smaller. Accordingly, occurrence of the slip stick phenomenon can be further restrained, and therefore the sliding sound can be restrained.

Aspect 21.

In Aspect 19 or Aspect 20, the member has the coat layer at a contact and slide portion (for example, the guide faces 262,267,272,273,342) where the member is in a stop state in which the member stops while being in contact with a sheet (for example, the sheet 400 and the original document 410) and in a moving state in which the member relatively slides on the sheet.

According to this configuration, as described in the test, occurrence of the slip stick phenomenon can be restrained or prevented when the sheet starts moving from the stop state, and therefore the sliding sound (chattering noise) is restrained or prevented from occurring.

Aspect 22.

In Aspect 19 or Aspect 20, the member has the coat layer at a contact and slide portion where the member is in a state in which the member stops while being in contact with a metal member and in a state in which the member relatively slides on the metal member.

According to this configuration, as described with reference to FIGS. 22 through 26, occurrence of the slip stick phenomenon can be restrained or prevented when the sliding surface of the member sliding on the metal member starts moving from the stop state, and therefore the sliding sound is restrained or prevented from occurring.

Aspect 23.

In Aspect 19 or Aspect 20, the member has the coat layer at a contact and slide portion where the member is in a stop state in which the member stops while being in contact with a resin member and in a moving state in which the member relatively slides on the resin member.

According to this configuration, occurrence of the slip stick phenomenon can be restrained or prevented when the sliding surface of the member sliding on the resin member starts moving from the stop state, and therefore the sliding sound is restrained or prevented from occurring.

Aspect 24.

In any one of Aspect 19 through Aspect 23, the coat layer has a surface roughness equal to or smaller than the surface roughness of the base material.

According to this configuration, as described in the embodiments above, the surface roughness of the sliding surface of the member on which the opposed member slides can be reduced due to the surface roughness. Accordingly, the sliding surface of the member with the reduced surface roughness slides on the opposed member. By so doing, when compared with a comparative configuration in which the base material slides on the opposed member, the sliding sound can be reduced.

Aspect 25.

In Aspect 24, the coat layer has a surface roughness Ra equal to or smaller than 0.2 μm and the base material has a surface roughness equal to or greater than 0.2 μm and equal to or smaller than 3 μm.

According to this configuration, as described in the above-described embodiments, the sound generated in sheet conveyance can be reduced more reliably for a long period of time and, at the same time, the base material can be manufactured easily, and therefore the manufacturing cost of the base material can be reduced.

Aspect 26.

In any one of Aspect 19 through Aspect 25, the coat layer has a film thickness equal to or smaller than 50 μm.

According to this configuration, as described in the embodiments above, even when the coat layer having the film thickness of 50 μm or smaller is provided to the member, a small impact is applied to an opposed member to slide on the member, and therefore a predetermined function can be maintained without changing the dimensions or position of the member.

Aspect 27.

In any one of Aspect 1 through Aspect 26, the coat layer has a film thickness greater than 10 μm.

According to this configuration, as described in the embodiments above, the function of the coat layer can be achieved reliably.

Aspect 28.

In any one of Aspect 19 through Aspect 27, the base includes a resin material.

According to this configuration, as described in the embodiments above, occurrence of the slip stick phenomenon caused by sliding between a resin and a metal, a resin and another resin, and a resin and a sheet can be restrained or prevented, and therefore the sliding sound can be restrained or prevented from occurring.

Aspect 29.

In any one of Aspect 19 through Aspect 28, the base includes at least a resin material and a filler.

According to this configuration, as described in the embodiments above, the rigidity and heat resistance of the member can be enhanced.

Aspect 30.

In any one of Aspect 19 through Aspect 29, the member is a sheet transfer guide disposed along a sheet conveyance passage through which a sheet passes and is provided to guide the sheet. The sheet transfer guide includes the coat layer at least on the guide surface to which the sheet contacts.

According to this configuration, as described in the embodiments above, the sound of sheet conveyance while the member is guiding the sheet can be reduced.

Aspect 31.

In Aspect 30, the guide surface to which the sheet contacts is curved in shape. According to this configuration, as described in the above-described embodiments, even when the sheet is slid and guided by the curved guide face on which a contact pressure (a sliding load) of the sheet tends to increase, the sound of sheet conveyance can be reduced for a long period of time.

Aspect 32.

In Aspect 30 or Aspect 31, the member includes at least one projection partially formed in a width direction of the sheet that is perpendicular to the sheet conveying direction and extending in the sheet conveying direction. The guide surface is a top surface of the projection.

According to this configuration, as described in the embodiments above, a good performance of sheet conveyance is maintained and the area forming the coat layer can be reduced.

Aspect 33.

In Aspect 33, an image forming apparatus (for example, the image forming apparatus 100) configured to convey the sheet (for example, the sheet 400) and form an image formed on the sheet includes the member according to any one of Aspect 19 through Aspect 32.

According to this configuration, the level of noise of the image forming apparatus can be restrained.

Aspect 34.

In Aspect 34, an image reading device (for example, the image reading device 300) configured to read an image formed on the sheet (for example, the original document 410) includes the member according to any one of Aspect 19 through Aspect 32.

According to this configuration, the level of noise of the image reading device can be restrained.

Aspect 35.

In Aspect 35, an automatic document feeder (for example, the ADF 310) configured to convey the sheet (for example, the original document 410) includes the member according to any one of Aspect 19 through Aspect 32.

According to this configuration, the level of noise of the automatic document feeder can be restrained.

The above-described embodiments are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of this disclosure may be practiced otherwise than as specifically described herein.

What is claimed is:

1. A detector contacting and detecting a sheet, the detector comprising:
a base;
a sheet contact face to which the sheet contacts; and
a coat layer formed on the sheet contact face.

2. The detector according to claim 1,
wherein the coat layer has a film thickness equal to or smaller than 50 μm.

3. The detector according to claim 1,
wherein the coat layer has a film thickness equal to or greater than 20 μm.

4. The detector according to claim 1,
wherein the coat layer does not move to the sheet in response to a contact with the sheet.

5. The detector according to claim 1,
wherein the coat layer has a surface roughness smaller than a surface roughness of the base.

6. The detector according to claim 5,
wherein the surface roughness of the coat layer is equal to or smaller than 0.2 μm, and
wherein the surface roughness of the base is equal to or greater than 0.2 μm and equal to and smaller than 3 μm.

7. The detector according to claim 1,
wherein a coefficient of friction of the coat layer to the sheet is smaller than a coefficient of friction of the base to the sheet.

8. The detector according to claim 1,
wherein the coat layer includes a resin containing a solid lubricant.

9. The detector according to claim 1,
wherein the base includes resin.

10. The detector according to claim 9,
wherein the base includes at least resin and reinforced fiber.

11. The detector according to claim 1, further comprising a rotary shaft rotatably supported and configured to rotate according to passing of the sheet in a sheet conveyance passage.

12. A sheet conveying device comprising:
a conveyance passage forming body configured to define a sheet conveyance passage;
a sheet conveying body configured to convey a sheet through the sheet conveyance passage;
the detector according to claim 11, configured to contact the sheet while the sheet is being conveyed through the sheet conveyance passage; and
a rotary detector configured to detect rotation of the detector.

13. An image forming apparatus comprising:
a conveyance passage forming body configured to define a sheet conveyance passage;
a sheet conveying body configured to convey a sheet through the sheet conveyance passage;
the detector according to claim 11, configured to contact the sheet while the sheet is passing through the sheet conveyance passage;
a rotary detector configured to detect rotation of the detector; and
an image forming device configured to form an image on the sheet.

14. An image reading device comprising:
a conveyance passage forming body configured to define a sheet conveyance passage;
a sheet conveying body configured to convey a sheet through the sheet conveyance passage;
the detector according to claim 11, configured to contact the sheet while the sheet is passing through the sheet conveyance passage;
a rotary detector configured to detect rotation of the detector; and
an image reader configured to read an image formed on the sheet.

15. The detector according to claim 1, further comprising a rotary shaft rotatably supported and configured to rotate according to presence of the sheet in a sheet container.

16. A sheet feeding device comprising:
a sheet container configured to contain a sheet;
the detector according to claim 15, configured to contact and detect the sheet contained in the sheet container; and
a rotary detector configured to detect rotation of the detector.

17. An image forming apparatus comprising:
a sheet container configured to contain a sheet;
the detector according to claim 15, configured to contact and detect the sheet contained in the sheet container;
a rotary detector configured to detect rotation of the detector; and
an image forming device configured to form an image on the sheet.

18. An image reading device comprising:
a sheet container configured to contain a sheet;
the detector according to claim 15, configured to contact and detect the sheet contained in the sheet container;
a rotary detector configured to detect rotation of the detector; and
an image reader configured to read an image formed on the sheet.
